(19) United States
(12) Patent Application Publication
(10) Pub. No.: US 2010/0268732 A1
(43) Pub. Date: Oct. 21, 2010

(54) PRINTING APPARATUS, IMAGE PROCESSING APPARATUS, IMAGE PROCESSING METHOD, AND COMPUTER PROGRAM

(75) Inventor: David Patrick Rohan, Wexford (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/762,219

(22) Filed: Apr. 16, 2010

(30) Foreign Application Priority Data
Apr. 17, 2009 (JP) 2009-100733

(51) Int. Cl. G06F 17/30; G06F 15/00

(52) U.S. Cl. 707/769; 358/1.15; 707/E17.03

(57) ABSTRACT

In image processing that performs an image search, user convenience is improved. An image processing apparatus includes a condition designation window display unit that displays a condition designation window which includes condition designation regions by stages for designating search conditions for features of image contents in a plurality of search stages in series relations with one another, and a plurality of tags that designate display states of the condition designation regions by stages as tags corresponding to the plurality of search stages; a search condition setting unit that sets the search conditions in the plurality of search stages in accordance with the designations through the condition designation window; and an image search unit that sequentially performs an image search for the plurality of search stages by using the set search conditions.

Priority is claimed under 35 U.S.C. §119 to Japanese Application No. 2009-100733 filed on Apr. 17, 2009, which is hereby incorporated by reference in its entirety.

### BACKGROUND

1. Technical Field

The present invention relates to image processing that performs image search.

2. Related Art

Image processing which sets search conditions for image attributes (e.g. a photographing time or photographing mode) and search conditions for features of the image contents (e.g. similarity for a predetermined template image), and performs an image search that detects an image suitable to the search conditions among a plurality of images have been proposed (for example, see JP-A-2004-272314).

According to an image processing of the related art that performs image search, in designating search conditions for used in the image search, there has been room for improvement of user convenience.

### SUMMARY

An advantage of some aspects of the invention is to improve the user convenience in image processing that performs image search.

In order to solve at least a part of the above-mentioned problems, the invention can be realized by the following forms or applications.

### Application 1

An image processing apparatus includes: a condition designation window display unit that displays a condition designation window which includes condition designation regions by stages for designating search conditions for features of image contents in a plurality of search stages in series relations with one another, and a plurality of tags that designate display states of the condition designation regions by stages as tags corresponding to the plurality of search stages; a search condition setting unit that sets the search conditions in the plurality of search stages in accordance with the designations through the condition designation window; and an image search unit that sequentially performs an image search for the plurality of search stages by using the set search conditions.

In this image processing apparatus, the condition designation window is displayed, the search conditions in the plurality of search stages are set in accordance with the designations through the condition designation window, and the image search for the plurality of search stages using the set search conditions is sequentially performed. Here, the condition designation window includes condition designation regions by stages for designating the search conditions for features of image contents in the plurality of search stages in series relations with one another, and a plurality of tags that designate display states of the condition designation regions by stages as tags corresponding to the plurality of search stages. Accordingly, a user can designate the search conditions for the features of image content in the plurality of search stages as changing the display state of the condition designation regions by stages. Accordingly, in this image processing apparatus, the user convenience can be improved in the image processing that performs the image search.

### Application 2

In the image processing apparatus as described in Application 1, the condition designation regions by stages are regions where one of the plurality of search conditions for realizing the image search, in which at least either of processing speeds and processing accuracies are different from one another, is designated as the search condition to be adopted.

In this image processing apparatus, a user can designate one of a plurality of search conditions for realizing the image search, in which at least either of the processing speeds and processing accuracies are different from one another, through the condition designation regions by stages of the condition designation window as the search condition to be adopted, and thus can easily set the search conditions for realizing the image search at a desired processing speed and processing accuracy. Accordingly, in this image processing apparatus, the user convenience can be improved in the image processing.

### Application 3

In the image processing apparatus as described in Application 1 or Application 2, the condition designation window display unit displays the condition designation window which includes a stage number designation region for designating the number of the search stages; and the search condition setting unit sets the search conditions in the search stages, the number of which is designated through the condition designation window.

In this image processing apparatus, since the condition designation window which includes a stage number designation region for designating the number of the search stages is displayed, and the search conditions in the search stages, the number of which is designated through the condition designation window is set, the user can easily designate the number of search stages (search steps) of which the search conditions can be independently set. Accordingly, in this image processing apparatus, the user convenience can be improved in the image processing that performs the image search.

### Application 4

The image processing apparatus as described in any one of Application 1 to Application 3 further includes a query image setting unit that sets a query image as the basis of the image search; in which the search condition setting unit sets the search condition on the similarity of the query image with the feature.

In this image processing apparatus, a query image as the basis of the image search is set, the search condition on the similarity of the query image with the feature of the image contents is set, and the image search for the plurality of search stages is sequentially performed using the set search condition. Accordingly, in this image processing apparatus, the user convenience can be improved in the image processing that performs the image search using the search condition on the similarity of the query image with the feature of the image contents.

### Application 5

In the image processing apparatus as described in Application 4, the query image setting unit sets an image that is specified by any one of methods for image file designation, portrayal, and color designation as the query image.

In this image processing apparatus, since an image that is specified by any one of methods for image file designation, portrayal, and color designation is set as the query image, the user can easily set a desired image as the query image. Accordingly, in this image processing apparatus, the user convenience can be improved in the image processing that performs the image search.

### Application 6

In the image processing apparatus as described in Application 4 or Application 5, the query image setting unit sets one image detected by the image search as a new query image.

In this image processing apparatus, since one image detected by the image search is set as a new query image, the user can reach a desired search result more efficiently by setting the detected image that is considered to be closer to a desired image as a new query image. Accordingly, in this image processing apparatus, the user convenience can be improved in the image processing that performs the image search.

### Application 7

In the image processing apparatus as described in any one of Application 4 to Application 6, the search condition setting unit sets the search condition on the similarity weighted for each image region.

In this image processing apparatus, since the search condition on the similarity weighted for each image region can be set and the user can perform the image search that attaches great importance to (or treats lightly) a specified image region, a desired image can be searched for more easily and efficiently. Accordingly, in this image processing apparatus, the user convenience can be improved in the image processing that performs the image search.

### Application 8

In the image processing apparatus as described in any one of Application 4 to Application 7, the search condition setting unit sets the search condition on the similarity weighted for each channel of a color space of the image.

In this image processing apparatus, since the search condition on the similarity weighted for each channel of a color space of the image can be set and the user can perform the image search that attaches great importance to (or treats lightly) a specified image region, a desired image can be searched for more easily and efficiently. Accordingly, in this image processing apparatus, the user convenience can be improved in the image processing that performs the image search.

### Application 9

In the image processing apparatus as described in any one of Application 1 to Application 8, the image search unit performs the image search of the rear-end search stage with respect to the image detected by the image search of the front-end search stage in the series relations.

In this image processing apparatus, since the image search of the rear-end search stage is performed with respect to the image detected by the image search of the front-end search stage in the series relations, the number of images to be searched in the rear-end search stage can be adjusted through adjustment of the search condition in the front-end search stage, and thus the user convenience can be improved in the image processing that performs the image search.

### Application 10

In the image processing apparatus as described in any one of Application 1 to Application 9, the search condition setting unit sets the search condition on attributes of the image in addition to the search condition on the features of the image contents; and the image search unit performs the image search using the search condition on the attributes of the image and the search condition on the features of the image contents.

In this image processing apparatus, since the search condition on attributes of the image is set in addition to the search condition on the features of the image contents, and the image search is performed using the search condition on the attributes of the image and the search condition on the features of the image contents, the image search for detecting a desired image can be performed more easily and efficiently. Accordingly, the user convenience can be improved in the image processing that performs the image search.

### Application 11

In the image processing apparatus as described in any one of Application 1 to Application 10, the condition designation window display unit displays the condition designation window in which the condition designation regions by stages that correspond to only one search stage are simultaneously displayed in accordance with the designation through the tags.

In this image processing apparatus, since the condition designation regions by stages that correspond to only one search stage are simultaneously displayed in the condition designation window, the user can designate the search condition on one search stage easily and clearly by performing the condition designation in the displayed condition designation regions by stages. Accordingly, in this image processing apparatus, the user convenience can be improved in the image processing that performs the image search.

### Application 12

In the image processing apparatus as described in any one of Application 1 to Application 11, the feature is at least either of the feature indicating color distribution in the image and the feature calculated by wavelet decomposition of the image.

In this image processing apparatus, in the image processing that performs image search that designates the search conditions on at least either of the feature indicating color distribution in the image and the feature calculated by wavelet decomposition of the image, the user convenience can be improved.

### Application 13

The image processing apparatus as described in any one of Application 1 to Application 12, further includes a print image setting unit that sets the detected image to be printed among the images detected by the image search, and a printing unit that performs printing of the detected image to be printed.

In this image processing apparatus, since the detected image to be printed is set among the images detected by the image search and printing of the detected image to be printed is performed, the user convenience can be improved in the print processing of the image detected by the image search.

### Application 14

The image processing apparatus as described in Application 13 further includes a search result window display unit that displays a search result window including a detected image display area for displaying the detected images in line and a print designation area for designating the detected image to be printed; in which the print image setting unit sets the detected image that corresponds to the image displayed in the print designation area according to a predetermined manipulation of a user in the search result window as the detected image to be printed.

In this image processing apparatus, since a search result window including a detected image display area for displaying the detected images in line and a print designation area for designating the detected image to be printed is displayed and the detected image that corresponds to the image displayed in the print designation area according to a predetermined manipulation of a user in the search result window is set as the detected image to be printed, the user can easily designate the detected image to be printed.

The invention can be realized in diverse forms such as, for example, image processing method and apparatus, image searching method and apparatus, printing method and apparatus, computer programs for realizing the above-mentioned methods or functions of the above-mentioned apparatuses, recording medium recorded with such computer programs, data signals including such computer programs and implemented within a carrier, or the like.

### BRIEF DESCRIPTION OF THE DRAWINGS

The invention will be described with reference to the accompanying drawings, wherein like numbers reference like elements.

FIG. 1 is an explanatory view schematically illustrating the configuration of a printer as an image processing apparatus according to a first embodiment of the invention.

FIG. 2 is a flowchart illustrating a flow of image search and print processing in the first embodiment of the invention.

FIG. 3 is an explanatory view illustrating an example of an initial window W1.

FIG. 4 is an explanatory view illustrating an example of an initial window W1.

FIG. 5 is an explanatory view illustrating an example of a search option window W2.

FIG. 6 is an explanatory view illustrating an example of a search option window W2.

FIG. 7 is an explanatory view illustrating an example of a multiple-choice of search conditions in a search using metadata.

FIG. 8 is an explanatory view illustrating an example of a multiple-choice of search conditions in a search using image contents.

FIG. 9 is an explanatory view illustrating an example of a search option window W2.

FIG. 10 is a flowchart illustrating a flow of search processing.

FIG. 11 is an explanatory view illustrating an example of a search result window W3.

FIG. 12 is an explanatory view illustrating an example of a search option window W2.

FIG. 13 is an explanatory view schematically illustrating the configuration of a printer as an image processing apparatus according to a second embodiment of the invention.

FIG. 14 is a flowchart illustrating a flow of image search and print processing in the second embodiment of the invention.

FIG. 15 is a flowchart illustrating a flow of search condition setting process.

FIG. 16 is an explanatory view illustrating an example of a multiple-choice table.

FIG. 17 is an explanatory view concretely illustrating a shape in which search stages and search conditions are set in the search condition setting process.

### DESCRIPTION OF EXEMPLARY EMBODIMENTS

Hereinafter, best modes (i.e. embodiments) for carrying out the invention will be described. The explanation will be made in the following order.

A. First embodiment
A-1. Configuration of an image processing apparatus
A-2. Image search and print processing
A-3. Feature amount distance calculation method
A-3-1. Regarding color histogram
A-3-2. Regarding Haar wavelet
B. Second embodiment
C. Modified examples

### A. First Embodiment

### A-1. Configuration of an Image Processing Apparatus

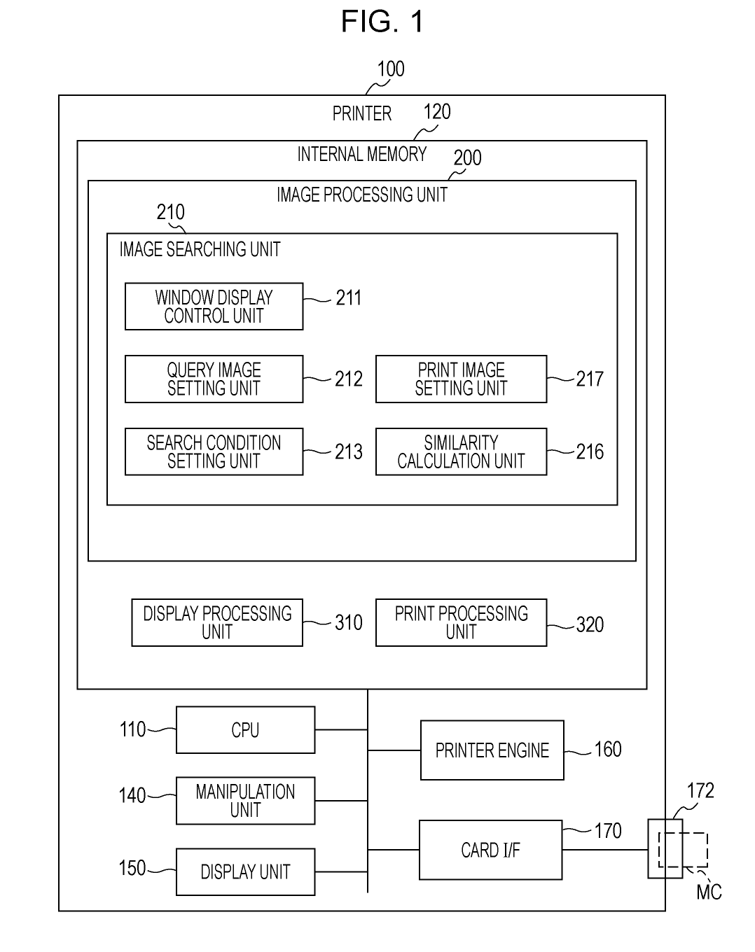

FIG. 1 is an explanatory view schematically illustrating the configuration of a printer 100 as an image processing apparatus according to a first embodiment of the invention. A printer 100 according to an embodiment of the invention is an ink jet type color printer corresponding to a so-called direct print, which prints an image based on image data acquired from a memory card MC or the like. The printer 100 includes a CPU 110 that controls respective units of the printer 100, an internal memory 120 composed of a ROM or RAM, a manipulation unit 140 composed of buttons or a touchpad, a display unit 150 configured by a liquid crystal monitor, a printer engine 160, and a card interface (card I/F) 170. The printer 100 may further include an interface for performing data communication with another device (e.g. a digital still camera or a personal computer). The respective configuration elements of the printer 100 are connected to one another through a bus.

The printer engine 160 is a printing tool that performs printing based on print data. The card interface 170 is an interface for performing data exchange with a memory card MC inserted into a card slot 172. In the embodiment of the invention, image files including image data are stored in the memory card MC.

In the internal memory 120, an image processing unit 200, a display processing unit 310, and a print processing unit 320 are stored. The image processing unit 200 may be a computer program that performs image search and print processing under a predetermined operating system. In the embodiment of the invention, the image search and print processing may be a process of performing an image search for detecting an image suitable to the search conditions and printing the detected image. Details of the image search and print processing will be described later.

The image processing unit 200, which is a program module, includes an image search unit 210. The image search unit 210 includes a window display control unit 211, a query image setting unit 212, a search condition setting unit 213, a similarity calculation unit 216, and a print image setting unit 217. Functions of these units will be described later in the following description of the image search and print processing.

The display processing unit 310 is a display driver that controls the display unit 150 to display a window screen that includes a processing menu and a message, an image, or the like, on the display unit 150. The print processing unit 320 is a computer program that generates print data from the image data, controlling the print engine 160, and performs printing of the image based on the print data. The CPU 110 realizes the functions of the respective units by reading from the internal memory 120 and executing the above-mentioned programs (i.e., the image processing unit 200, the display processing unit 310, and the print processing unit 320).

### A-2. Image Search and Print Processing

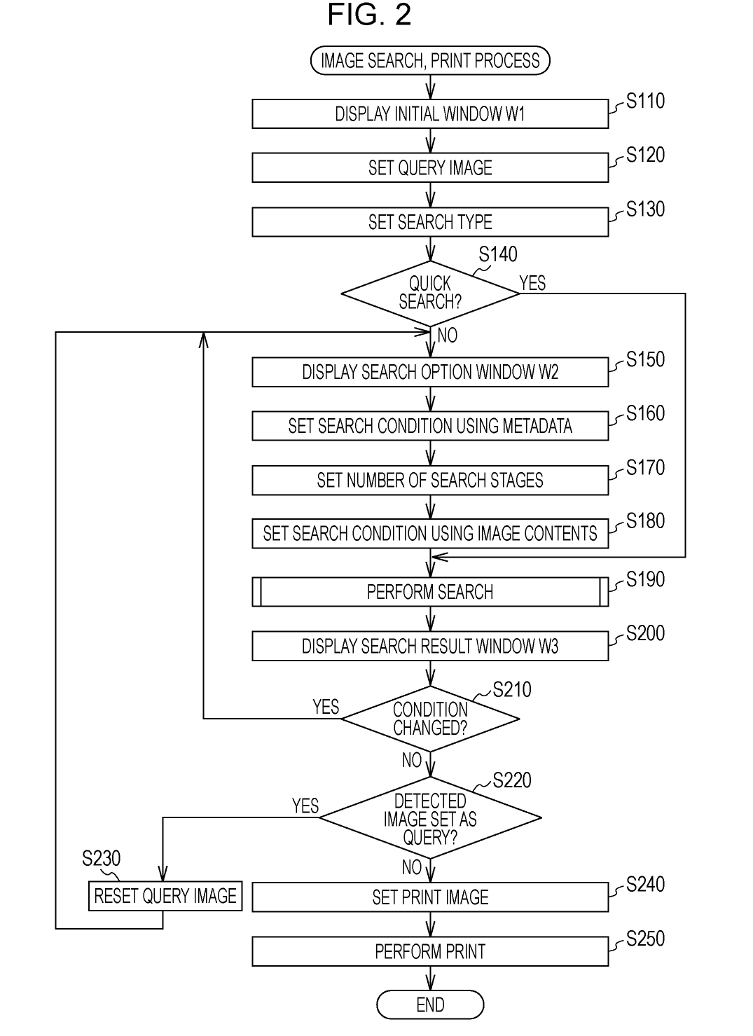

FIG. 2 is a flowchart illustrating a flow of image search and print processing in the first embodiment of the invention. In this embodiment, the image search and print processing is a process that performs image search for detecting an image suitable to the search conditions among a plurality of target images, and performs printing of the detected image. In this embodiment, the printer 100 can perform image search based on the features of the image contents in addition to the image search based on the attributes of the image. The image search based on the features of the image contents is performed by detecting an image having a large similarity (i.e. the degree of similarity) to a query image that is the basis of image search with respect to predetermined features of the image contents among target images to be searched. More specifically, the feature amount distance that indicates the similarity between the query image and the target image with respect to the predetermined features of the image contents is detected, and the target images having the feature amount distance that is equal to or less than the maximum feature amount distance. The target image may be optionally set, and in the embodiment of the invention, the image stored in the memory card MC (i.e. image data included in an image file) is set as the target image.

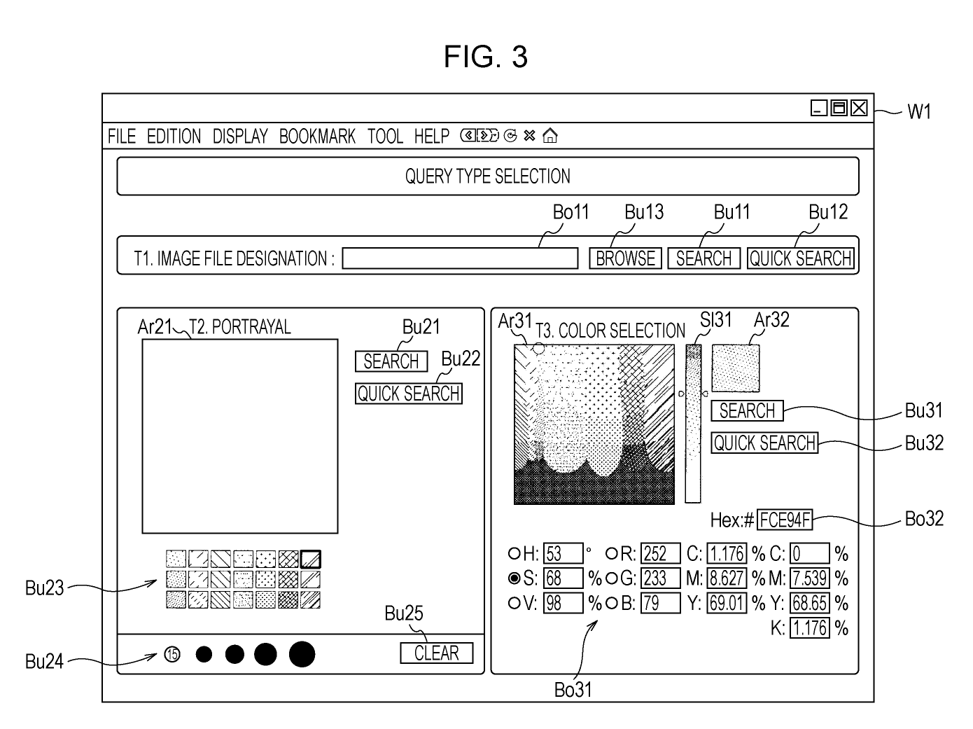

If the image search and print processing (see FIG. 2) starts according to a user's instruction through the manipulation unit 140 (see FIG. 1), the window display control unit 211 controls the display processing unit 310 to display an initial window W1 on the display unit 150 (step S110). FIG. 3 is an explanatory view illustrating an example of the initial window W1. The initial window W1 is a window that includes the query image in the image search and a user interface for designating the image search type.

In this embodiment of the invention, it is possible to designate the query image in three different methods. That is, as methods for designating the query image, a method T1 by designation of image files, a method T2 by portrayal, and a method T3 by color selection have been proposed. As illustrated in FIG. 3, the initial window W1 includes user interfaces that correspond to the three query image designating methods.

That is, the initial window W1 (see FIG. 3) includes, as the interface for the method T1 by designation of image files, an input box Bo11 for inputting a path that specifies a position of an image file, and a browser button Bu13 for indicating the window for layer-selecting the image file. A user can designate an image to be set as a query image by directly inputting a path of the image file through the input box Bo11 or selecting the image file in the window that is displayed when the browser button Bu13 is pressed.

The initial window W1 (see FIG. 3) also includes, as the interface for the method T2 by portrayal, color pallet buttons Bu23 including a plurality of different color buttons, and pen diameter designation buttons Bu24 including a plurality of pen buttons with different diameters. A user can designate an image to be set as a query image by portraying an image in a portrayal area Ar21 using the color pallet buttons Bu23 or the pen diameter designation buttons Bu24. In this case, in the initial window W1, a clear button Bu25 for deleting an image is also included. At this time, the portrayal process in the initial window W1 is realized, for example, using a Java script (registered trademark) portrayal tool.

The initial window W1 (see FIG. 3) also includes, as the interface for the method T3 by color selection, an input box Bo31 for inputting channel values in a specified color system (e.g. an HSV color system or an RGB color system), a color designation area Ar31 for selecting a color by designating one point in a color gradation, and a slider Sl31 for designating a position according to a specified color axis (e.g. an axis of hue or an axis of saturation). A user can select a specified color by inputting channel values in the specified color system through the input box Bo31, designating one point in the color designation area Ar31, or designating a position according to the axis in the slider Sl31, and accordingly can designate an image (i.e. a beta image configured by one selected color) to be set as the query image. In this case, the color selected by the user is displayed in the color display area Ar32. Also, in the input box Bo31, the respective channel values in the plurality of color systems correspond to each other, and for example, if a certain channel value is changed in the HSV color system, the respective channel values in the RGB color system or the CMY color system are automatically changed. Also, radio buttons in the input box Bo31 is to designate an axis in the slider Sl31, and for example, if a radio button that is in the position of an S channel in the HSV color system is selected, the slider Sl31 corresponds to the axis of hue. Also, the plurality of interfaces for the method T3 by the color selection in the initial window W1 correspond to each other, and for example, if one point is designated in the color designation area Ar31, the values in the respective color systems that indicates the color of the designated point are displayed in the input box Bo31. Also, in a code display box Bo32, a code that indicates the designated color is displayed. The color selection process in the initial window W1 may be realized, for example, using a Java script color pallet.

Also, in this embodiment of the invention, as the image search types, two kinds of searches, i.e. a typical search and a quick search are provided. The typical search is a search type that performs an image search by setting the search conditions in detail, and the quick search is a search type that performs the image search by using the search conditions set by default without performing a detailed setting of the search conditions. In the initial window W1, for the three methods T1, T2, and T3 for setting the query image, buttons Bu11, Bu21, and Bu31 for starting the typical search and buttons Bu12, Bu22, and Bu32 for starting the quick search are included.

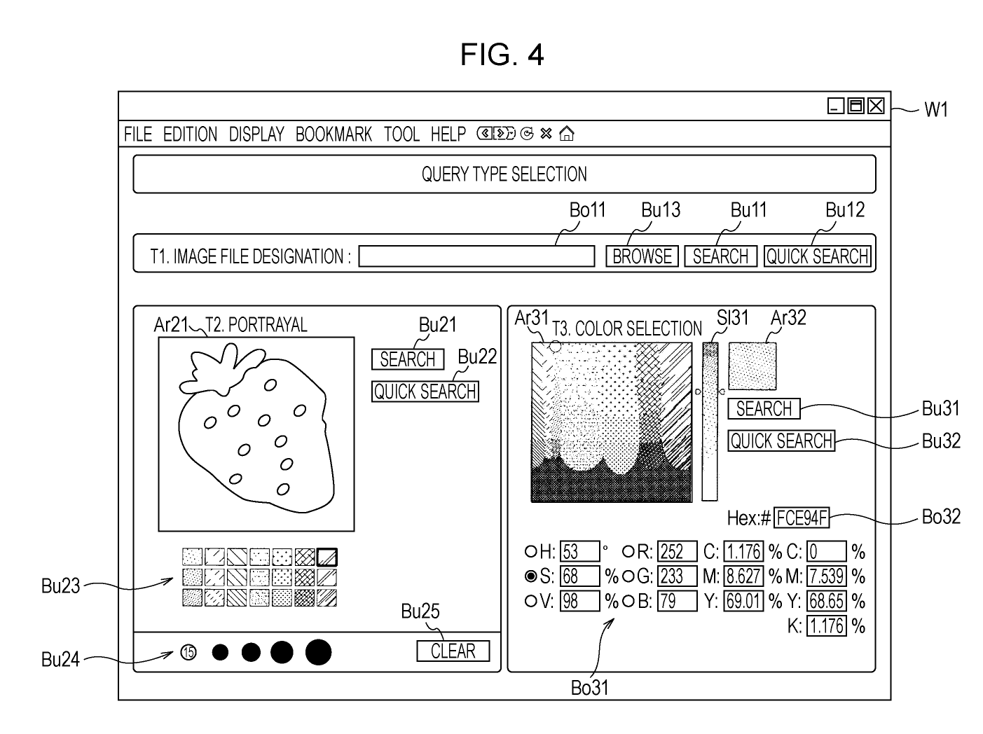

In the initial window W1 (see FIG. 3), if one button for starting the image search is selected by the user, the query image setting unit 212 (see FIG. 1) sets the query image (step S120 in FIG. 2), and the image search unit 210 sets the search type (step S130). That is, the search type (i.e. the typical search or the quick search) that corresponds to the button selected by the user is set as the search type to be used, and the image designated by the query image designation method that corresponds to the selected button is set as the query image. In FIG. 4, an example of the initial window W1 in the case where the query image is designated by portrayal is illustrated. For example, as shown in FIG. 4, if an image is portrayed in the portrayal area Ar21 by the user and the button Bu21 for starting the typical search that corresponds to the query image designation method by portrayal is selected, the image generated by the portrayal is set as the query image, and the typical search is set as the search type.

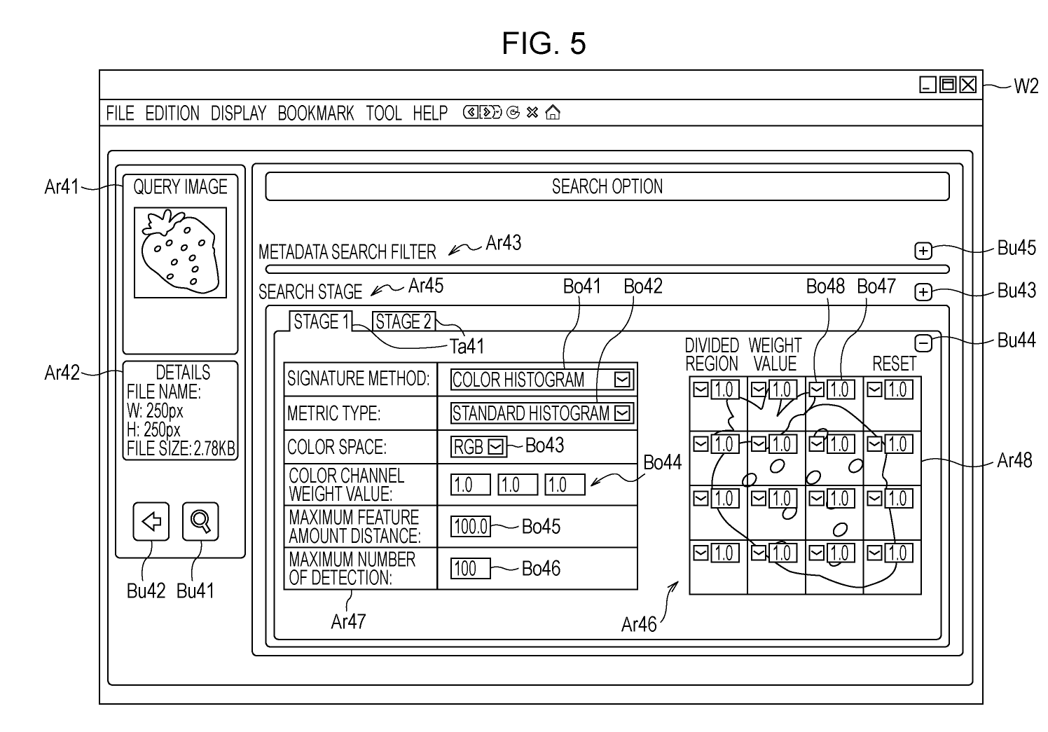

In the initial window W1 (see FIG. 3), if buttons Bu11, Bu21, and Bu31 for starting the typical search is set (“No” in step S140 in FIG. 2), the window display control unit 211 (see FIG. 1) controls the display processing unit 310, and displays the search option window W2 on the display unit 150 (step S150). FIG. 5 is an explanatory view illustrating an example of the search option window W2. The search option window W2 is a window that includes a user interface for designating the search conditions in detail in the image search. In this case, the search option window W2 corresponds to the condition designation window according to an embodiment of the invention, and a window display control unit 211, a display processing unit 310, and a display unit 150 function as a condition designation window display unit according to an embodiment of the invention.

As shown in FIG. 5, the search option window W2 includes a query image display area Ar41 for displaying the query image and an attribute display area Ar42 for displaying an attribute (e.g. a file name or a file size) of the query image. Also, as described above, the printer 100 according to this embodiment of the invention can perform the image search based on metadata (hereinafter referred as to “search using metadata”) that displays the attribute of the image and the image search based on the features of the image contents (hereinafter referred to as “search using image contents”). Accordingly, the search option window W2 includes a metadata condition designation area Ar43 for designating the search conditions for the search using metadata, and a contents condition designation area Ar45 for designating the search conditions for the search using image contents.

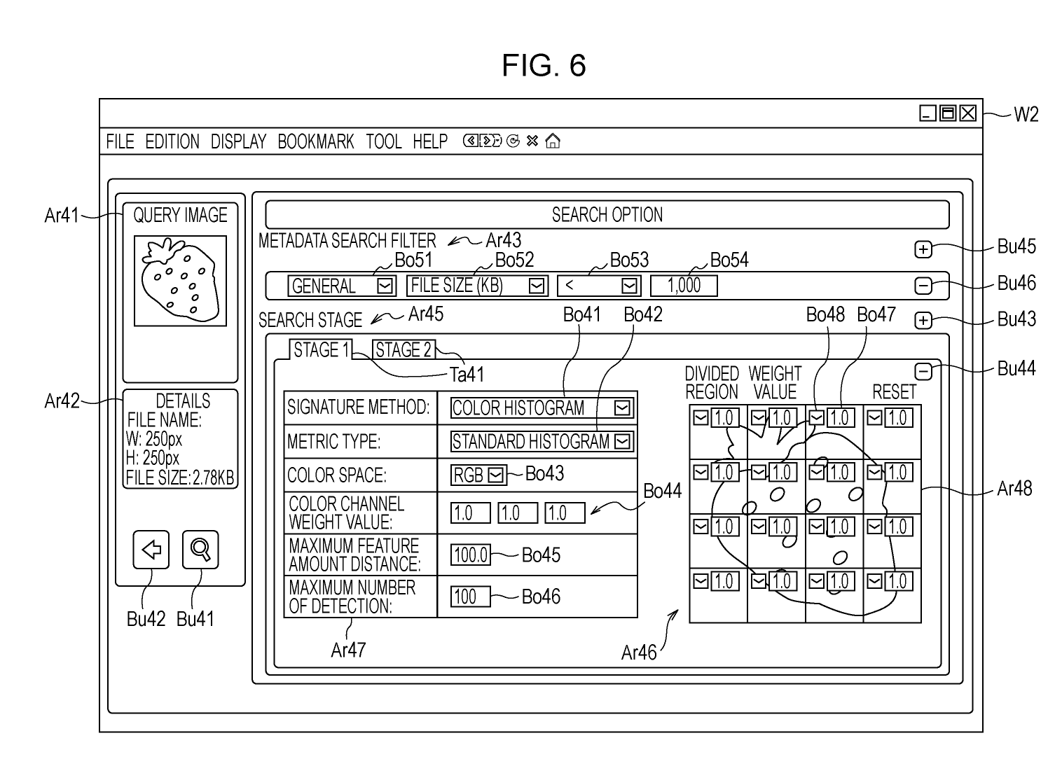

In the search option window W2 (see FIG. 5), a plus button Bu45 arranged in the neighborhood of the metadata condition designation area Ar43 is a button for adding the search conditions for the search using metadata. If the plus button Bu45 is selected, as shown in FIG. 6, a box set for designating one search condition for the search using metadata is additionally displayed in the metadata condition designation area Ar43. Also, a minus button Bu46 is a button for deleting one search condition for the search using metadata.

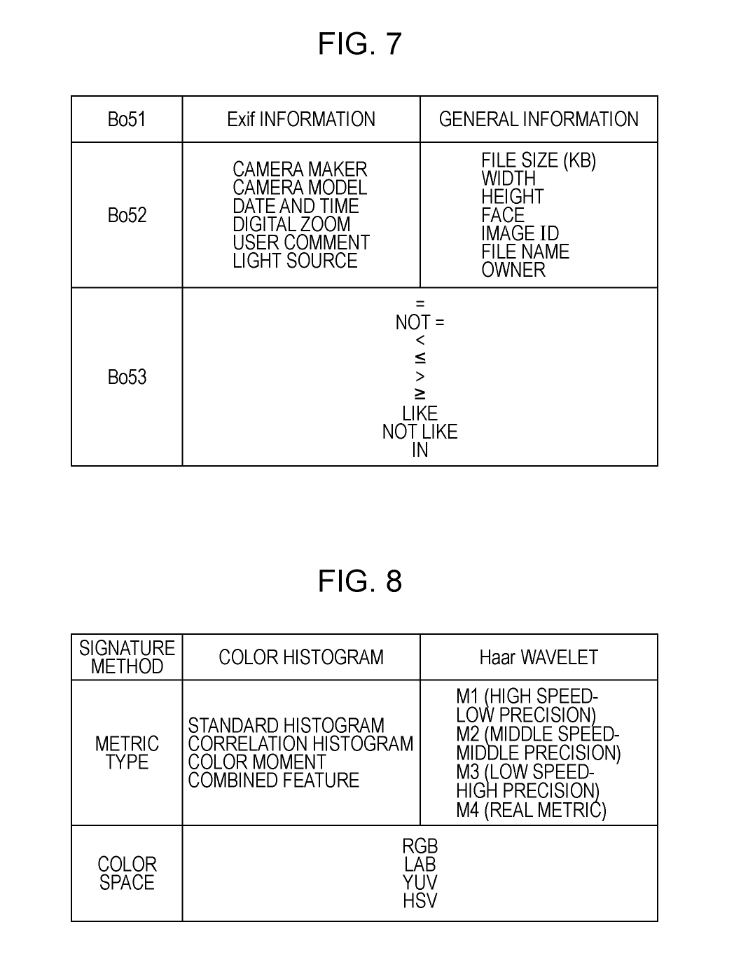

As shown in FIG. 6, the box set for designating one search condition for the search using metadata is composed of a box Bo51 for designating the type of metadata, a box Bo52 for designating items of metadata, a box Bo53 for designating a sign of inequality or the like in the search conditions, and a box Bo54 for designating values in the search conditions. The designation in the boxes Bo51, Bo52, and Bo53 is performed by the selection in a full down menu. FIG. 7 is an explanatory view illustrating an example of a multiple-choice of the search conditions for the search using metadata. In this embodiment of the invention, as shown in FIG. 7, as the multiple-choice of the metadata type (i.e. multiple-choice in the box Bo51), two kinds of information, i.e. Exif information and general information are set. Also, as the multiple-choice of the metadata items (i.e. multiple-choice in the box Bo52), a camera maker, a camera model, a photographing time, or the like, are set corresponding to the Exif information, and a file size, an image size (e.g. width and height), the number of detected face images, or the like, are set corresponding to the general information. A user can designate, for example, the search condition that “The file size is smaller than 1,000 kB” by selecting a desired multiple-choice in the boxes Bo51, Bo52, and Bo53 and inputting the values in the box Bo54.

If the plurality of search conditions for the search using metadata are set in the metadata condition designation area Ar43, a box (not illustrated) for designating whether the relation between the respective search conditions is “and” or “or” is displayed, and thus it is possible to designate the mutual relation between the respective search conditions. Also, if even one of the search conditions is not set in the metadata condition designation area Ar43, the search using metadata is not performed.

The printer 100 according to the embodiment of the invention may set a plurality of search stages having series relations with each other. If the plurality of search stages are set in the search using image contents, the image detected as suitable to the search conditions in the front end search stage in the series relations is selected as the target image of the rear end search stage.

In the search option window W2 (see FIG. 5), a plus button Bu43 arranged in the neighborhood of a contents condition designation area Ar45 is a button for adding a search stage for the search using the image contents. If the plus button Bu43 is selected, one search stage is added, and a search stage prescription area Ar46 for prescribing the search condition in one search stage is added to the contents condition designation area Ar45. Also, a minus button Bu44 is a button for deleting one search stage. To each search stage, a tag Ta41 for designating the display state of the search stage prescription area Ar46 corresponds, and if a plurality of search stages are set, a search stage prescription area Ar46 corresponding to one search stage is displayed in accordance with the selection of the tag Ta41, and a search stage prescription area Ar46 corresponding to another search stage is in a non-display state. In this case, in the search option window W2, the plus button Bu43 and the minus button Bu44 correspond to the state number designation area, and the search stage prescription area Ar46 corresponds to the stage condition designation area in the embodiment of the invention. If even one search stage is not set in the contents condition designation area Ar45, the search using image contents is not performed.

In the search option window W2 (see FIG. 5), the search stage prescription area Ar46 is an area for designating the search condition in the corresponding search stage. In this embodiment of the invention, it is possible to designate the search condition by selection among multiple-choices of a plurality of search conditions so that at least either of the processing speed and the accuracy becomes different from each other in a state where the image search is performed using the search condition. The search stage prescription area Ar46 includes a condition designation area Ar48 for designating the search condition and a weight designation area Ar47 for designating a weight value for each divided area of the image. As shown in FIG. 5, the condition designation area Ar47 includes a box Bo41 for designating a signature method, a box Bo42 for designating a metric type, a box Bo43 for designating a color space, a box Bo44 for designating a weight value of each color channel of a color space, a box Bo45 for designating the maximum feature amount distance, and a box Bo46 for designating the maximum number of detections.

The designation in the boxes Bo41, Bo42, and Bo43 of the condition designation area Ar47 (see FIG. 5) is performed by a selection in full down menu. FIG. 8 is an explanatory view illustrating an example of a multiple-choice of the search conditions for the search using image contents. The color space designated by the box Bo43 is a color space used to set the search conditions, and in the embodiment of the invention, as shown in FIG. 8, RGB, LAB, YUV, and HSV are set as the multiple-choice of the color space.

The signature method designated by the box Bo41 of the condition designation area Ar47 (see FIG. 5) is the feature of the image contents used for the search using image contents. In the embodiment of the invention, as shown in FIG. 8, a color histogram and a Haar wavelet are set as a multiple-choice of the signature method. Also, the metric type designated by the box Bo42 corresponds to a method of calculating a similarity between the query image for the predetermined feature of image contents and the target image (i.e. an index value indicating the similarity and a method of calculating the corresponding index value). In the embodiment of the invention, as shown in FIG. 8, a standard histogram, a correlation histogram, a color moment, and a combined feature are set as a metric type multiple-choice corresponding to the color histogram, and a high-speed low-accuracy metric M1, a middle-speed middle-accuracy metric M2, a low-speed high-accuracy metric M3, and a metric M4 as a real metric are set as a metric type multiple-choice corresponding to the Haar wavelet.

The color histogram (see FIG. 8) as the signature method is a feature that indicates a color distribution of an image expressed in a predetermined color space. In the embodiment of the invention, as the color histogram, a pixel frequency distribution in a plurality of color bins set by quantizing the respective channels prescribing the color space is used. For example, in the case where an RGB color space is used, the pixel frequency distribution in 64 color bins set by quantizing the respective RGB channels into four equal parts (e.g. if the range of the channel values is 0 to 255, they are quantized into four ranges of 0 to 63, 64 to 127, 128 to 191, and 192 to 255) is used. In the case of adopting the color histogram as the signature method, the amount of computation is small in comparison to a case that adopts the Haar wavelet, and thus the image search speed is improved. In contrast, since the color histogram has no space information, the accuracy of image search often deteriorates. For example, there is a possibility that an image with a similar feature of color distribution as the whole image is detected although the detected image has a low similarity according to the human interpretation. In this case, it is not necessary that the quantization levels when the color bins are set are equal to each other in each channel. For example, in the case where a HSV color space is used, the H channel is more finely quantized than the S channel and the V channel.

The standard histogram (see FIG. 8) as the metric type multiple-choice corresponding to the color histogram corresponds to a method of calculating the similarity between the query image for the color histogram and the target image using the pixel frequency itself in the respective color bins. Also, the correlation histogram corresponds to a method of calculating the similarity between the query image and the target image using an accumulated value of the pixel frequency in the color bin. For example, if it is assumed that the pixel frequency in the respective N color bins is Hᵢ (where, i=1, 2, 3, . . . , N), the accumulated value of pixel frequency Cj (j=1, 2, 3, . . . , N) is calculated by the following Equation (1). In the case where the correlation histogram is adopted as the metric type, the image search speed somewhat deteriorates in comparison to the standard histogram, but the occurrence of mismatch that causes a quantization error is suppressed to improve the accuracy of image search.

$$\begin{matrix}Equation ( 1 ) & \\ {C}_{j} = {\sum }_{i = 1}^{j} {H}_{i} & ( 1 )\end{matrix}$$

Also, the color moment (see FIG. 8) as the metric type multiple-choice corresponding to the color histogram corresponds to a method of calculating the similarity between the query image for the color histogram and the target image using three kinds of color moments of an average μ of pixel frequency in the color bins, dispersion σ², and a degree of distortion γ³. Also, the combined feature corresponds to a method of calculating the similarity between the query image and the target image by using an index F obtained by combining three color moments (i.e. an average μ, dispersion σ², and a degree of distortion γ³). The index F obtained by combining the average μ, dispersion σ², and the degree of distortion γ³ is calculated by the following Equations (2) to (5). In this case, W_{F} in Equation (5) denotes a weight coefficient set by experiments. In the case where the color moment or the combined feature is adopted as the metric type, the image search speed becomes high in comparison to the standard histogram, but the accuracy of the image search deteriorates.

$$\begin{matrix}Equation ( 2 ) & \\ μ = \frac{1}{N} {\sum }_{i = 1}^{N} {H}_{i} & ( 2 ) \\ Equation ( 3 ) & \\ {σ}^{2} = \frac{1}{N} {\sum }_{i = 1}^{N} {( {H}_{i} - μ )}^{2} & ( 3 ) \\ Equation ( 4 ) & \\ {γ}^{3} = \frac{1}{N} {\sum }_{i = 1}^{N} {( {H}_{i} - μ )}^{3} & ( 4 ) \\ Equation ( 5 ) & \\ F = \frac{{w}_{F} \cdot μ \cdot γ}{σ} & ( 5 )\end{matrix}$$

The Haar wavelet as the signature method corresponds to wavelet coefficients calculated by wavelet decomposition of an image that uses the Haar wavelet as a base. In the case where the Haar wavelet is adopted as the signature method, the amount of computation is large in comparison to a case that adopts the color histogram, and thus the image search speed is lowered. In contrast, since Haar wavelet has space information of the image, the accuracy of the image search may be improved.

All the high-speed low-accuracy metric M1, the middle-speed middle-accuracy metric M2, and the low-speed high-accuracy metric M3, as the metric type multiple-choices corresponding to the Haar wavelet, correspond to a method of calculating the similarity between the query image and the target image using the Haar wavelet coefficients calculated by the Haar wavelet decomposition of the image. The high-speed low-accuracy metric M1, the middle-speed middle-accuracy metric M2, and the low-speed high-accuracy metric M3 have different image resolutions when they perform the Haar wavelet decomposition. That is, the high-speed low-accuracy metric M1 is a method that uses the Haar wavelet coefficients calculated by the Haar wavelet decomposition with respect to a relatively low-resolution image, and the middle-speed middle-accuracy metric M2 is a method that uses the Haar wavelet coefficients calculated by the Haar wavelet decomposition with respect to a middle-resolution image. The low-speed high-accuracy metric M3 is a method that uses the Haar wavelet coefficients calculated by the Haar wavelet decomposition with respect to a relatively high-resolution image. As the resolution of the image for which the Haar wavelet decomposition is performed becomes higher, the image search speed becomes lower, but the accuracy of the image search is improved.

Also, the real metric M4 as the metric type multiple-choice is a method of calculating the similarity between the query image and the target image using Haar wavelet coefficients calculated by the Haar wavelet decomposition of the image. The real metric M4 is different from the metric M1, the metric M2, and the metric M3 at the point that it uses a method having symmetry when calculating the similarity (i.e. feature amount distance) between the query image and the target image.

The concrete method of calculating the similarity (i.e. feature amount distance) between the query image and the target image for a predetermined feature of the image will be described in “A-3. feature amount distance calculation method:” to be described later.

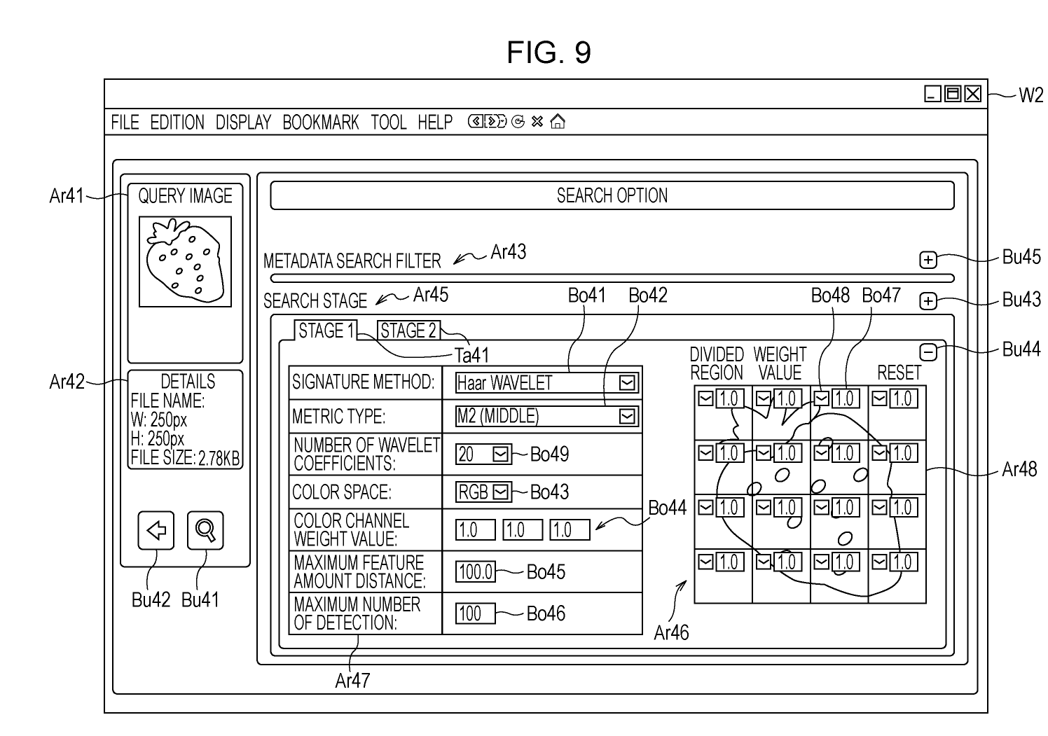

In the case where the Haar wavelet is selected as the signature method, as shown in FIG. 9, in the condition designation area Ar47 of the search option window W2, a box Bo49 for designating wavelet series coefficients Cu is displayed. The wavelet series coefficients Cu correspond to the number of wavelet coefficients (for one channel) that is used in calculating the similarity (i.e. feature amount distance) between the query image for the Haar wavelet and the target image. The wavelet series coefficient Cu may be an index value that indicates low compression rate of the image. That is, if the total number of Haar wavelet coefficients is Ca, the (Ca-Cu)-numbered wavelet coefficients having the smallest value are thrown away (i.e. the values become zero). As the number of wavelet series coefficients Cu becomes smaller, the similarity calculation process is performed with low-speed and high-accuracy, while as the number of wavelet series coefficients becomes larger, the similarity calculation process is performed with low-speed and high-accuracy.

Weight values of the respective color channels in a color space designated by the box Bo44 in the condition designation area Ar47 (see FIG. 5) are weight values of the respective color channels which are reflected in calculation of the similarity between the query image for the features of the image contents and the target image. The maximum feature amount distance that is designated by the box Bo45 in the condition designation area Ar47 is the threshold value of the similarity (i.e. feature amount distance) between the query image and the target image in the image search. That is, in the corresponding search stage, a target image of which the similarity (i.e. feature amount distance) between the query image and the target image is equal to or less than the maximum feature amount distance. The maximum number of detections designated by the box Bo46 in the condition designation area Ar47 is the maximum number of permitted target images detected as suitable to the search conditions in the corresponding search stage.

The weight designation area Ar48 of the search stage prescription area Ar46 in the search option window W2 (see FIG. 5) is divided into plural (in this embodiment, 16) regions in the form of a lattice, and in each divided region, the weight designation box Bo47 and the check box Bo48 are arranged. In the weight designation area Ar48, a query image is displayed, and thus the query image is divided into plural regions. The weight designation box Bo47 is a box for designating the weight value of each region of the image in calculating the similarity (i.e. feature amount distance) between the query image and the target image. Also, by removing a check in the check box Bo48 of a certain divided region, it can be designated that the corresponding region is not considered in calculating the similarity between the query image and the target image.

In the condition designation area Ar47 and the weight designation area Ar48 of the search stage prescription area Ar46 of the search option window W2 (see FIG. 5), the user can individually designate the method of calculating the similarity (i.e. feature amount distance) between the query image and the target image in the respective search stages by selecting the signature method or metric type, selecting the color space, designating the weight value of each channel, or designating the weight value of each region of the image. Also, the user can designate the threshold value of the respective search stages, which corresponds to the set degree of similarity between the query image and the target image, by designating the maximum feature amount distance in the condition designation area Ar47. Also, the user can designate the upper limit of the image detected in the respective stages by designating the maximum number of detections in the condition designation area Ar47.

If the search condition is designated in the metadata condition designation area Ar43 of the search option window W2 (see FIG. 5) by the user, the search condition setting unit 213 (see FIG. 1) sets the search condition in the search using metadata (step S160 in FIG. 2). Also, if the number of search stages is set in the contents condition designation area Ar45 of the search option window W2 by the user, the search condition setting unit 213 sets the number of search stages for the search using image contents (step S170). Also, if the search condition is designated in the search stage prescription area Ar46 by the user, the search condition setting unit 213 sets the search condition in the respective search stages for the search using image contents (step S180). In this case, the search condition setting unit 213 also sets the execution order of the respective search stages based on the designation in the search stage prescription area Ar46. In the embodiment of the invention, stage numbers (e.g. “STAGE 1” or the like in FIG. 5) are attached to the respective search stages, and the search stages are performed in the order of stage number, e.g. the search stage having a smaller stage number is performed earlier.

The search option window W2 (see FIG. 5) includes a search execution button Bu41 and a return button Bu42. If the return button Bu42 is selected in the search option window W2, the initial window W1 (see FIG. 3) is displayed again in the display unit 150 (see FIG. 1). If the search execution button Bu41 is selected in the search option window W2, the search execution (step S190 in FIG. 2) starts.

Also, if buttons Bu12, Bu22, and Bu32 for starting the quick search in the initial window W1 (see FIG. 3) are selected (“Yes” in step S140 in FIG. 2) by the user, detailed setting of search conditions (steps S150 to S180) using the search option window W2 is skipped, and a search execution process using the search condition preset by default starts (step S190).

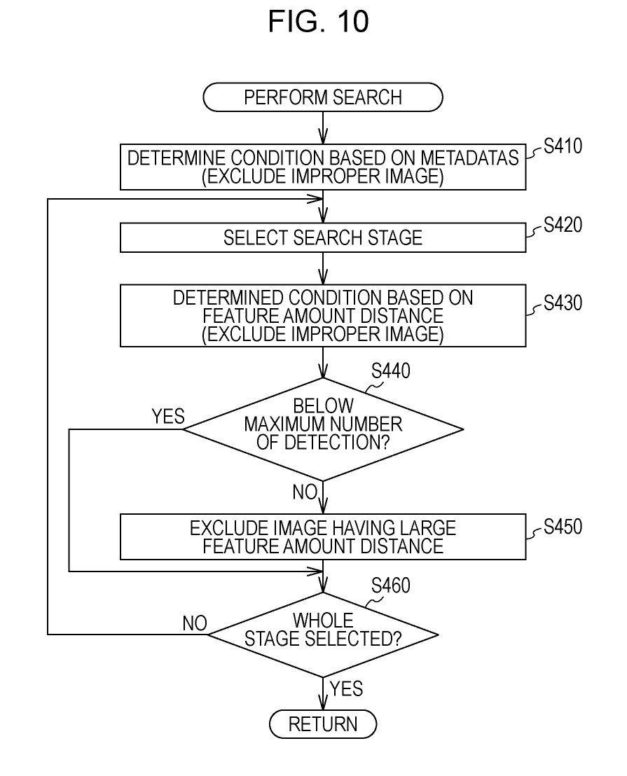

FIG. 10 is a flowchart illustrating a flow of the search execution process. In step S410, the image search unit 210 (see FIG. 1) performs the condition determination based on metadata. Specifically, the image search unit 210 acquires metadata by interpreting the image file of the target image, and determines whether the attribute of the target image that is specified by the acquired metadata is suitable to the search condition for the set metadata (e.g. the search condition that “the file size is smaller than 1,000 kB”, see FIG. 6). The image search unit 210 excludes the target image determined not to be suitable to the search condition from the search processing. In this case, if even one search condition is not designated in the metadata condition designation area Ar43 of the search option window W2 (see FIG. 5), the process of the step S410 is skipped.

In step S420 (see FIG. 10), the image search unit 210 (see FIG. 1) selects one search stage for the search using image contents. As described above, in the embodiment of the invention, the search stages are selected in the order of their number. For example, as shown in FIG. 5, if two search stages of the search stage “stage 1” of the stage number 1 and the search stage “stage 2” of the stage number 2 are set, the search stage “stage 1” is first selected.

In step S430 (see FIG. 10), the image search unit 210 (see FIG. 1) performs the condition determination based on the feature amount distance. Specifically, a similarity calculation unit 216 of the image search unit 210 calculates the similarity (i.e. feature amount distance) between the query image and the target image for the features of the image contents, and a face feature position specifying unit 210 determines whether the calculated feature amount distance is shorter than the maximum feature amount distance. The image search unit 210 excludes the target image of which the calculated feature amount distance is longer than the maximum feature amount distance from the subsequent search processing.

For example, in the search condition set with respect to the selected search stage, as shown in FIG. 5, if the signature method is a “color histogram”, the metric type is “standard histogram”, and the color space is “RGB”, the pixel frequency Hᵢ of the respective color bins in the RGB color space is calculated as the feature amount with respect to the query image and the target image, and the feature amount distance that indicates the similarity of the feature amounts (i.e. pixel frequency Hi) of both images is calculated. Then, it is determined whether the calculated feature amount distance is shorter than the maximum feature amount distance (e.g. 100). Also, if the signature method is a “Haar wavelet”, the metric type is “metric M1”, and the color space is “RGB”, the Haar wavelet coefficients in the RGB color space are calculated with respect to the query image and the target image, and the feature amount distance that indicates the similarity of both images is calculated based on the Haar wavelet coefficients. In this case, if the weight value of the color channel is set in the box Bo44 of the condition designation area Ar47 or if the weight value of the divided region is set in the weight designation area Ar48, the feature amount distance is calculated in consideration of the weight value. Also, it is enough that the calculation of the feature amount of the query image is performed only once. Also, the calculation of the feature amount of the target image of the query image may be pre-performed before the search execution is processed. With respect to other signature method or metric type, the calculation can be made in the same manner. The method of calculating the feature amount distance will be described in more detail later.

In step S440 (see FIG. 10), the image search unit 210 (see FIG. 1) determines whether the number of target images which have not yet been excluded at that time is equal to or smaller than the set maximum number of detections (See Bo46 in FIG. 5). If the number of target images which have not yet been excluded is larger than the set maximum number of detections (“No” in step S440), the image search unit selects and excludes the target images the number of which exceeds the maximum number of detections in the largest first order of their feature amount distance (step S450). On the other hand, if the number of target images which have not yet been excluded is equal to or smaller than the set maximum number of detections (“Yes” in step S440), the process in step S450 is skipped.

In step S460 (see FIG. 10), the image search unit 210 (see FIG. 1) determines whether all the search stages have been selected. If there is any search stage that has not yet been selected (“No” in step S460), the non-selected search stage having the smallest stage number is selected (step S420), and the search using the image contents set with respect to the selected search stage is performed (steps S430 to S450). In this case, in the embodiment of the invention, in the condition determination in the search stages subsequent to the second search stage, only the feature amount distance calculated in the corresponding search stage is considered. However, in the condition determination in the search stages subsequent to the second search stage, the total distance which is the sum of the feature amount distance calculated in the corresponding search stage and the feature amount distance calculated in the search stage of which the execution has been completed is calculated, and it is determined whether the total distance is smaller than the maximum feature amount total distance as the threshold value. If it is determined that all the search stages have been selected in step S460 (“Yes” in step S460), the search execution process is completed. In this case, the non-excluded target image becomes the detected image Di in the image search.

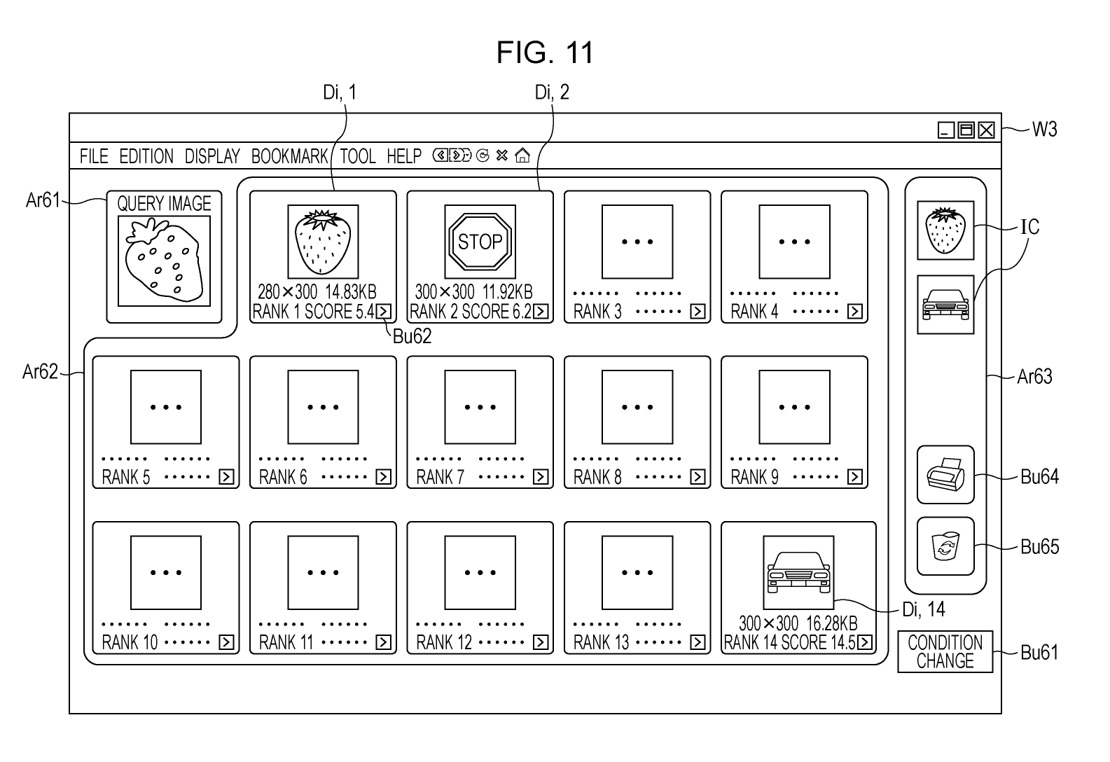

If the search execution process (step S190 in FIG. 2) is completed, the windows display control unit 211 (see FIG. 1) controls the display processing unit 310 to display a search result window W3 on the display unit 150 (step S200). FIG. 11 is an explanatory view illustrating an example of a search result window W3. The search result window W3 is a window for displaying the target image detected in the search execution processing (i.e. detected image Di). That is, as shown in FIG. 11, in the search result window W3, a detected image display area Ar62 is included in addition to a query image display area Ar61. In the detected image display area Ar62, the detected images Di are displayed in line in the order of their rank (i.e. in the order of their score) indicating the overall similarities with the query image. The scores of the respective detected image Di are calculated based on the feature amount distances. In the embodiment of the invention, the feature amount distance calculated in the final search stage for the search using image contents becomes the score. This is because, in general, it is quite often that the signature method or metric type having the highest accuracy is set with respect to the final search stage. In this case, the score may be the sum of an average of the feature amount distances calculated in the respective search stages for the search using image contents, or the weight sum or the weight average of the feature amount distances calculated in the respective search stages.

In the search result window W3 (see FIG. 11), a condition change button Bu61 is included. If the condition change button Bu61 is selected by the user (“Yes” in step S210 in FIG. 2), the search option window W2 (see FIG. 5) is displayed again (step S150), and thus re-setting of the search conditions or the re-execution of the search (steps S160 to S200) becomes possible.

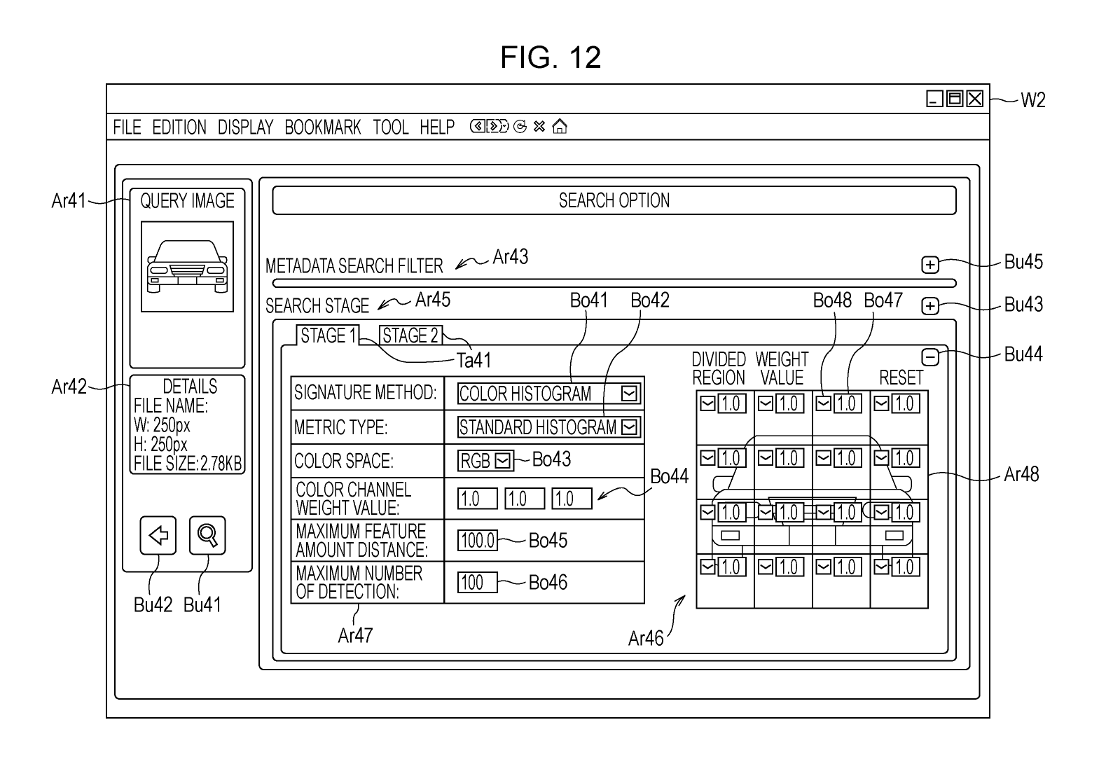

In the detected image display area Ar62 of the search result window W3 (see FIG. 11), query setting buttons Bu62 that correspond to the respective detected images Di are included. The query setting button Bu62 is a button for instructing to set the detected image Di as a new query image. If the query setting button Bu62 is selected in the search result window W3 by the user (“Yes” in step S220 in FIG. 2), the re-setting of a query image (step S230) in which the detected image Di that corresponds to the selected query setting button Bu62 becomes a new query image is performed, and the search option window W2 is displayed again (step S150). FIG. 12 shows the search option window W2 in which the detected image Di 14 has become a new query image in the case where the query setting button Bu62 corresponding to the detected image Di 14 is selected in the search result window W3 (see FIG. 11). In performing the image search in a state where the detected image Di has become a new query image, the user may maintain the search condition as it is or may change the search condition.

Also, in the search result window W3 (see FIG. 11), a print designation area Ar63 is included. In the search result window W3, the user can designate the detected image Di to be printed by displaying an icon IC of the detected image Di on the print designation area Ar63 through a drag-and-drop manipulation of the icon of the detected image Di onto the print designation area Ar63 (step S240 in FIG. 2). In an example of FIG. 11, two detected images Di are designated as images to be printed. In the print designation area Ar63, a print execution button Bu64 and a print designation canceling button Bu65 are included. The user can cancel the print designation of the corresponding image by simultaneously selecting the icon IC of the image displayed in the print designation area Ar63 and the print designation canceling button Bu65 (or by performing a drag-and-drop manipulation of the icon IC of the image onto the print designation canceling button Bu65). Also, the user can instruct the print execution start of the detected image Di that corresponds to the icon IC displayed in the print designation area Ar63 by selecting the print execution button Bu64. If the print execution start is instructed, the print processing unit 320 (see FIG. 1) generate print data based on the image data of the designated detected image Di, and controls the print engine 160 to print the detected image Di (step S250 in FIG. 2).

As described above, in the image search and print processing by the printer 100 according to an embodiment of the invention, the user can designate in detail the search condition of the image search through the search option window W2 (see FIG. 5). That is, the search option window W2 includes a search stage prescription area Ar46 for designating the search condition for the features of the image contents in a plurality of search stages having series relations with one another, and tags Ta41 that correspond to the respective search stages for designating the display state of the search stage prescription area Ar46, and the user can easily designate the search conditions of the respective search stages as changing the display state of the search stage prescription area Ar46 through the tags Ta41. Once the search condition is designated through the search option window W2, the search conditions in the respective search stages are set according to the designation through the search option window W2, and the image search in the plurality of search stages are sequentially performed using the set search conditions. Accordingly, in the image search and print processing by the printer 100 according to the embodiment of the invention, the user convenience can be improved in the image processing that performs the image search.

Also, in the image search and print processing by the printer 100 according to the embodiment of the invention, since in the search stage prescription area Ar46 of the search option window W2, the search condition can be designated by selecting a multiple-choice of a plurality of search conditions (i.e. the signature method, metric type, wavelet series coefficient, or the like) so that at least either of the speed and the accuracy of the image search process differs, the search using the image contents can be realized at a desired processing accuracy and processing speed, and thus the user convenience in the image search can be improved. For example, a search condition using a signature method (e.g. color histogram) in which a relatively high-speed low-accuracy search process is realized is set with respect to the first search stage, and a search condition using a signature method (e.g. Haar wavelet) in which a relatively low-speed high-accuracy search process is realized is set with respect to the second search stage, so that a high-speed condition determination is performed for a large amount of target image in the first search stage, and the number of target images in the second search stages that performs high-accuracy condition determination can be suppressed. Accordingly, the search using image contents with a good balance between the processing accuracy and the processing speed can be realized. In the same manner, for example, by simultaneously setting the search condition using a metric type (e.g. metric M1) in which a relatively high-speed low-accuracy search process is realized with respect to the first search stage and setting the search condition using a metric type (e.g. metric M3) in which a relatively low-speed high-accuracy search process is realized with respect to the second search stage, the search using image contents with a good balance between the processing accuracy and the processing speed can be realized. In these cases, by adjusting the maximum feature amount distance (i.e. threshold value of condition determination) of the first search stage, the number of target images to be processed in the second search stage can be adjusted, and thus the balance between the processing accuracy and the processing speed in the search using the image contents can be adjusted. Also, since the respective signature methods or the respective metric types have their own detection characteristics, the detection characteristics are complemented between the search stages by performing the search using the image contents by using the plurality of search stages that use different signature methods or metric types, and thus the possibility that an image having a low similarity according to the human interpretation is detected can be reduced. Also, in the image search and print processing by the printer 100 according to the embodiment of the invention, since the search using metadata and the search using image contents are unable to be combined, the user convenience in the image search can be improved.

Also, in the image search and print processing by the printer 100 according to the embodiment of the invention, since the search option window W2 includes an interface (e.g. a plus button Bu43 and a minus button Bu44) for increasing or decreasing the number of search stages, the user can easily designate the number of search stages, and thus the user convenience in the search using the image contents can be improved.

Also, in the image search and print processing by the printer 100 according to the embodiment of the invention, a query image is set as the basis of the search using the image contents and the search conditions for the similarity of the query image to the features of the image contents are set, the search using the image contents for detecting an image similar to the query image with respect to the features of the specified image contents can be realized. Also, in the image search and print processing by the printer 100 according to the embodiment of the invention, in the initial window W1 (see FIG. 3), the query image can be designated by one method of image file designation, portrayal, and color designation, and thus the user convenience can be improved in the search using the image contents that detects an image similar to the query image. Also, in the image search and print processing by the printer 100 according to the embodiment of the invention, since one of the detected images Di detected by the image search can be set as a new query image, the user can reach a desired result of search more efficiently by setting the detected image Di that is considered to be closer to a desired image as the new query image, and thus the user convenience can be further improved in the search using the image contents.

Also, in the image search and print processing by the printer 100 according to the embodiment of the invention, since the search option window W2 includes the weight designation area Ar48 for designating the weight values for respective regions of an image, the search condition for the weighted similarity can be set for respective regions of the image, and thus the user convenience can be further improved in the search using the image contents. In the same manner, in the image search and print processing by the printer 100 according to the embodiment of the invention, since the search option window W2 includes the box Bo44 for designating the weight values of the respective channels in the color space, the search condition for the weighted similarity for each channel of the color space of the image can be set, and thus the user convenience can be further improved in the search using the image contents.

Also, in the image search and print processing by the printer 100 according to the embodiment of the invention, the detected image to be printed is set among the detected images Di detected by the image search, and thus the detected image Di to be printed can be printed. In the image search and print processing by the printer 100 according to the embodiment of the invention, since the search result window W3 (see FIG. 11) includes the detected image display area Ar62 for displaying the detected images Di and the print designation area Ar63 for designating the detected image Di to be printed, and the detected image Di that corresponds to the image (e.g. icon IC) displayed in the print designation area Ar63 is set as the detected image Di to be printed according to the user's specified manipulation, the user can readily designate the detected image Di to be printed, and thus the user convenience can be improved in the image search and print processing.

### A-3. Feature Amount Distance Calculation Method

Hereinafter, in the condition determination process (step S430) based on the feature amount distance of the above-described search execution process (see FIG. 10), a concrete method of calculating the feature amount distance by the similarity calculation unit 216 will be described. The feature amount distance is an index that indicates the similarity between the query image and the target image for the specified features of the image contents.

### A-3-1. Regarding Color Histogram

In the embodiment of the invention, in the condition setting (step S180 in FIG. 2) for the search using the image contents, the metric type multiple-choice in the case where the signature method is set as a color histogram is set by a standard histogram, a correlation histogram, a color moment, and a combined feature (see FIG. 8). In the case where the metric type is set as the standard histogram, a square D²(Q, T) of the feature amount distance D(Q, T) is calculated by the following Equation (6). In Equation (6), H_{Qi} is a pixel frequency of the i-th color bin of the query image, H_{Ti} is a pixel frequency of the i-th color bin of the target image, and N is the number of color bins.

$$\begin{matrix}Equation ( 6 ) & \\ {D}^{2} ( Q , T ) = {\sum }_{i = 1}^{N} {( {H}_{Qi} - {H}_{Ti} )}^{2} & ( 6 )\end{matrix}$$

In the case where the metric type is set as the correlation histogram, a square D²(Q, T) of the feature amount distance D(Q, T) is calculated by the following Equation (7). In Equation (7), C_{Qi} is an accumulated value (see Equation (1)) of the pixel frequency H_{Qi} of the first to j-th color bins of the query image, C_{Tj} is an accumulated value of the pixel frequency H_{Ti} of the first to j-th color bins of the target image, and N is the number of color bins.

$$\begin{matrix}Equation ( 7 ) & \\ {D}^{2} ( Q , T ) = {\sum }_{j = 1}^{N} {( {C}_{Qi} - {C}_{Tj} )}^{2} & ( 7 )\end{matrix}$$

In the case where the metric type is set as the color moment, the feature amount distance D(Q, T) is calculated by the following Equation (8). In Equation (8), D_{RED}(Q, T) is the feature amount distance in an R channel, and is calculated by the following Equation (9). In Equation (9), μ_{Q} and μ_{T} are averages of the pixel frequencies Hᵢ of color bins regarding the R channels of the query image and the target image (see Equation (2)), σ_{Q} and σ_{T} are square roots (i.e. standard deviation) of dispersion of the pixel frequencies Hᵢ of color bins regarding the R channels of the query image and the target image (see Equation (3)), and γ_{Q} and γ_{T} are cube roots of skewness of the pixel frequencies Hᵢ of color bins regarding the R channels of the query image and the target image (see Equation (4)). w_{μ}, w_{σ}, and w_{γ} are weight coefficients set by experiments. Also, D_{GREEN}(Q, T) and D_{BLUE}(Q, T) in Equation (8) are feature amount distances in G and B channels, respectively, and are calculated by the following Equation (9).

D(Q,T)=D_{RED}(Q,T)+D_{GREEN}(Q,T)+D_{BLUE}(Q,T) Equation (8)

D_{RED}(Q,T)=w_{μ}|μ_{Q}−μ_{T}|+w_{σ}|σ_{Q}−σ_{T}|+w_{γ}|γ_{Q}−γ_{T}| Equation (9)

Also, in the case where the metric type is set as the combined feature, the feature amount distance D(Q, T) is calculated by the above-described Equation (8). In this case, however, D_{RED}(Q, T) in Equation (8) is calculated by the following Equation (10). In Equation (10), F_{Q} and F_{T} are combination indexes regarding the R channels of the query image and the target image (see Equation (5)), and w_{R} is a weight coefficient set by experiments. In Equation (8), D_{GREEN}(Q, T) and D_{BLUE}(Q, T) are feature amount distances in G and B channels, respectively, and are calculated by the following Equation (10).

D_{RED}(Q,T)=w_{R}|F_{Q}−F_{T}| Equation (10)

### A-3-2. Regarding Haar Wavelet

In the embodiment of the invention, in the condition setting (step S180 in FIG. 2) for the search using the image contents, the metric type multiple-choice in the case where the signature method is set as Haar wavelet is set to a high-speed low-accuracy metric M1, a middle-speed middle-accuracy metric M2, a low-speed high-accuracy metric M3, and a metric M4 as a real metric (see FIG. 8). As described above, the metrics M1, M2, and M3 have different resolution of the image when the Haar wavelet decomposition is performed, but adopt the same feature amount distance calculation method. If the metric type is set to metrics M1, M2, and M3, the feature amount distance D(Q, T) is calculated by the following Equation (11). In Equation (11), k denotes a width and a height of an image that is the subject of Haar wavelet decomposition, Q(i, j) and T(i, j) are wavelet coefficients in the coordinates (i, j) of the results of Haar wavelet decomposition of the query image and the target image, respectively. Here, as the wavelet coefficients, a specified number of wavelet coefficients having much smaller values are thrown away, and then values of which the quantization has been performed are used. The throwing-up of the wavelet coefficients is performed in a manner that based on the designated wavelet series coefficients Cu in the box Bo49 of the search option window W2 (see FIG. 9), the wavelet coefficients of the wavelet series coefficients Cu having the largest value remain as they are, and the values of other wavelet coefficients (having relatively small values) become zero. Also, in the embodiment of the invention, the quantization of the wavelet coefficients is a process in which a positive value is transformed into +1 and a negative value is transformed into −1, and is prescribed by the following Equation (12). In Equation (11), w(i, j) is a weight coefficient set by experiments. Also, in Equation (11), [Q(i, j)≠₁T(i, j)] is a comparison value of the wavelet coefficient of the query image and the wavelet coefficient of the target image, and is prescribed in the following Equation (13). That is, the feature amount distance D(Q, T) is a weighted sum of the wavelet coefficient of the query image and the wavelet coefficient of the target image, with respect to the coordinates in which the wavelet coefficient of the query image is not zero.

$$\begin{matrix}Equation ( 11 ) & \\ D ( Q , T ) = {\sum }_{{i , j = 1}_{Q ( i , j ) \neq 0}}^{k} w ( i , j ) [ Q ( i , j ) {\neq }_{1} T ( i , j ) ] & ( 11 )\end{matrix}$$

Q(i,j)=−1, if Q(i,j)<0

Q(i,j)=+1, if Q(i,j)>0 Equation (12)

[Q(i,j)≠₁T(i,j)]=1, if Q(i,j)≠T(i,j)

[Q(i,j)≠₁T(i,j)]=0, if Q(i,j)=T(i,j) Equation (13)

In this case, Equation (11) includes diverse improvements in high-speed calculation of the feature amount distance D(Q, T). That is, in Equation (11), the improvements include the use of quantized wavelet coefficients, omission of scaling function coefficients (i.e. coefficients corresponding to coordinates (0, 0)), excluding the coordinates in which the wavelet coefficient Q(i, j) of the query image is zero from the subject of the total summing, and considering only the coordinates in which the wavelet coefficient Q(i, j) is not zero as the subject of total summing. In this case, since the calculation of the feature amount distance D(Q, T) in the case where the signature method is set as Haar wavelet is described in C. E Jacobs, A. Finkelstein, D. H. Salesin “Fast Multiresolution Image Querying” (Proceedings of 1995 ACM SIGGRAPH Conference, Los Angeles Calif., USA, Aug. 9-11, pp. 277-286, 1995), the detailed description thereof will be omitted.

In the embodiment of the invention, the real metric M4 as a metric type is a search condition that is used in an image search method using a search algorithm called Linear Approximating and Eliminating Search Algorithm (hereinafter called as “LAESA”). LAESA is a pivot base search algorithm. The pivot base search algorithm is a search algorithm that calculates distances among a plurality of pivot points preset as a preprocess in order to reduce the distance calculation amount in the search processing, and in the search processing, it detects the points at which it is not possible to satisfy the search conditions and excludes the points from the subject of distance calculation. Since pivot base search algorithm or LAESA is described in Maria Luisa Mico, Jose Oncina, “A new version of the Nearest-Neighbour Approximating and Eliminating Search Algorithm (AESA) with linear preprocessing time and memory requirements” (Pattern Recognition Letters vol. 15, p. 9-p. '7, January 1994, or Edgar Chavez, J. L, Marroquin, Ricardo Baeza-Yates, {Spaghettis: An Array Based Algorithm for Similarity Queries in Metric Spaces} (spire, pp. 38, String Processing and Information Retrieval Symposium & International Workshop on Groupware, 1999), the detailed description thereof will be omitted.

In the case of adopting the image search method using a pivot base search algorithm such as LAESA, it is necessary to adopt a method having symmetry as the method of calculating the feature amount distance D(Q, T). The method having symmetry is a method of calculating the feature amount distance that is unchanged between the query image and the target image even though the relations between the query image and the target image are reversed, and the method having symmetry satisfies the following Equation (14).

D(Q,T)=D(T,Q) Equation (14)

In the case where the metric type is set as the metrics M1, M2, and M3, the method of calculating the feature amount distance D(Q, T) (i.e. the Equation (11)) has no symmetry since the coordinates at which Q(i, j) is zero is excluded from the subject of total summing. Accordingly, it is not possible to adopt the calculation method in the case where the metric type is set as the real metric M4.

In the embodiment of the invention, the feature amount distance D(Q, T) in the case where the metric type is set as the real metric M4 is calculated by a method prescribed in the following Equation (15). In Equation (15), k denotes a width and a height of an image that is the subject of Haar wavelet decomposition, Q(i, j) and T(i, j) are wavelet coefficients (i.e. values after throwing-up and quantization) in the coordinates (i, j) of the results of Haar wavelet decomposition of the query image and the target image, respectively. In Equation (15), w(i, j) is a weight coefficient set by experiments. Also, in Equation (15), [Q(i, j)=₂T(i, j)] is a comparison value of the wavelet coefficient of the query image and the wavelet coefficient of the target image, and is prescribed in the following Equation (16).

$$\begin{matrix}Equation ( 15 ) & \\ D ( Q , T ) = {\sum }_{{i , j = 1}_{T ( i , j ) \neq 0}}^{k} w ( i , j ) + {\sum }_{{i , j = 1}_{Q ( i , j ) \neq 0}}^{k} w ( i , j ) [ Q ( i , j ) {=}_{2} T ( i , j ) ] & ( 15 )\end{matrix}$$

[Q(i,j)=₂T(i,j)]=−1, if Q(i,j)=T(i,j)

[Q(i,j)≠₂T(i,j)]=+1, if Q(i,j)≠T(i,j) Equation (16)

As shown in Equation (15), the feature amount distance D(Q, T) in the case where the metric type is set as the real metric M4 is the total sum of the weighted sum of the comparison value of the wavelet coefficient of the query image and the wavelet coefficient of the target image with respect to the coordinates at which the wavelet coefficient Q(i, j) of the query image is not zero, and the sum of weight coefficients w(i, j) with respect to the coordinates at which the wavelet coefficient T(i, j) of the target image is not zero.

In comparison Equation (15) to Equation (11), the sum of weight coefficients w(i, j) corresponding to the coordinates at which the wavelet coefficient T(i, j) of the target image is not zero is added to Equation (15) as a correction term. The method of calculating the feature amount distance D(Q, T) prescribed by Equation (15) has symmetry as described below with reference to Equation (17).

$$Equation ( 17 )$$

$$\begin{matrix}D ( Q , T ) = {\sum }_{{i , j = 1}_{T ( i , j ) \neq 0}}^{k} w ( i , j ) + \\ {{\sum }_{{i , j = 1}_{Q ( i , j ) \neq 0}}}^{k} w ( i , j ) [ Q ( i , j ) {=}_{2} T ( i , j ) ] \\ = {\sum }_{{i , j = 1}_{T ( i , j ) \neq 0}}^{k} w ( i , j ) + \\ {{\sum }^{k}}_{{i , j = 1}_{Q ( i , j ) \neq 0}} w ( i , j ) [ \vert Q ( i , j ) - T ( i , j ) \vert - \vert T ( i , j ) \vert ] \\ = {\sum }_{{i , j = 1}_{T ( i , j ) \neq 0}}^{k} w ( i , j ) \vert T ( i , j ) \vert + \\ {{\sum }^{k}}_{{i , j = 1}_{Q ( i , j ) \neq 0}} w ( i , j ) [ \vert Q ( i , j ) - T ( i , j ) \vert - \vert T ( i , j ) \vert ] \\ = {\sum }_{i , j = 1}^{k} w ( i , j ) \vert T ( i , j ) \vert + \\ {\sum }_{i , j = 1}^{k} w ( i , j ) [ \vert Q ( i , j ) - T ( i , j ) \vert - \vert T ( i , j ) \vert ] \\ = {\sum }_{i , j = 1}^{k} w ( i , j ) \vert Q ( i , j ) - T ( i , j ) \vert\end{matrix} \qquad ( 17 )$$

The uppermost stage of Equation (17) is the same as Equation (15). The second stage of Equation (17), as described below, is equivalent to the uppermost stage of Equation (17). That is, if it is assumed that Q(i, j)=T(i, j)(≠0), an equation of |Q(i, j)−T(i, j)|−|T(i, j)|=−|T(i, j)|=−1 is materialized. Next, if it is assumed that Q(i, j)≠T(i, j) and T(i, j)=0, an equation of |Q(i, j)−T(i, j)|−|T(i, j)|=|Q(i, j)|=1 is materialized. Last, if it assumed that Q(i, j)≠T(i, j) and T(i, j)≠0, an equation of |Q(i, j)−T(i, j)|−|T(i, j)|=2−1=1 is materialized. Accordingly, in all cases, the second stage of Equation (17) of |Q(i, j)−T(i, j)|−|T(i, j)| is equal to the uppermost stage of Equation (17) of Q(i, j)=₂T(i, j).

Since in the case of T(i, j)≠0, an equation of |T(i, j)|=1 is materialized, the third stage of Equation (17) is equivalent to the second stage of Equation (17). Since in the first term of the third stage of Equation (17), if it is assumed that T(i, j)=0, |T(i, j)|=0 is materialized, the total sum of the first term is the same even if the condition of T(i, j)≠0 is subtracted. Also, since in the second term of the third stage of Equation (17), if it is assumed that Q(i, j)=0, |Q(i, j)−T(i, j)|−|T(i, j)|=0 is materialized, the total sum of the second term is the same even if the condition of Q(i, j)≠0 is subtracted. Accordingly, the third stage of Equation (17) may be rewritten as the fourth stage. Also, by combining the first term and the second term in the fourth stage of Equation (17), the fourth stage of Equation (17) may be rewritten as the fifth stage. Since Equation (14) is materialized, the fifth stage of Equation (17) has symmetry. Accordingly, Equation (15) that is equivalent to the fifth stage of Equation (17) has symmetry.

As described above, since the method of calculating the feature amount distance D(Q, T) prescribed by Equation (15) has symmetry, it can be adopted as the method of calculating feature amount distance D(Q, T) in the case where the image search is performed using a pivot-base search algorithm. According to the method of calculating the feature amount distance D(Q, T) prescribed by Equation (15), in calculating the total sum (i.e. the second term of a right side of the equation (15)) of the comparison values of the wavelet coefficient Q(i, j) of the query image and the wavelet coefficient T(i, j) of the target image, the case in which the wavelet coefficient Q(i, j) of the query image is zero is excluded, and thus the calculation speed of the feature amount distance D(Q, T) can be improved. Also, since the first term (i.e. correction term) of the right side of Equation (15) depends on only the target image, but does not depend on the query image, it is possible to calculate the feature amount distance as a preprocess of the image search. Accordingly, by the method of calculating the feature amount distance D(Q, T) in Equation (15), a high processing speed of the image search process using the pivot base search algorithm such as LAESA and the suppression of the processing time can be realized.

### B. Second Embodiment

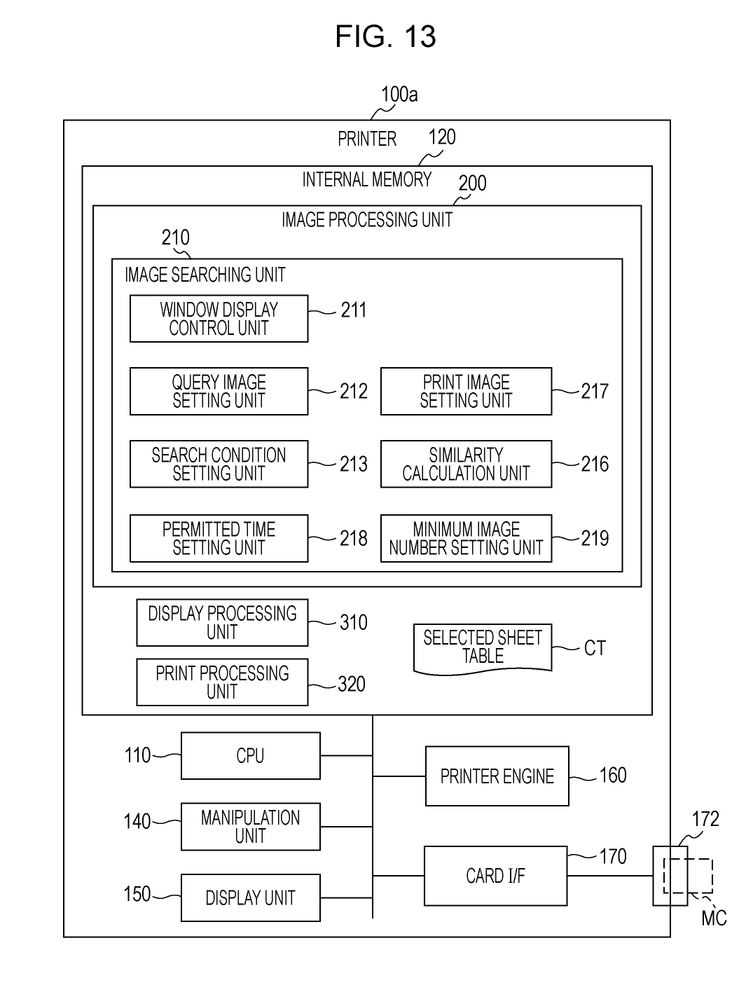

FIG. 13 is an explanatory view schematically illustrating the configuration of the printer 100a as the image processing apparatus according to the second embodiment of the invention. The printer 100a according to the second embodiment of the invention is different from the printer 100 according to the first embodiment of the invention as shown in FIG. 1 on the point that the image search unit 210 includes a permitted time setting unit 218 and a minimum image number setting unit 219, and a multiple-choice table CT is stored in the internal memory 120. Another configuration of the printer 100a is the same as that in the printer according to the first embodiment of the invention.

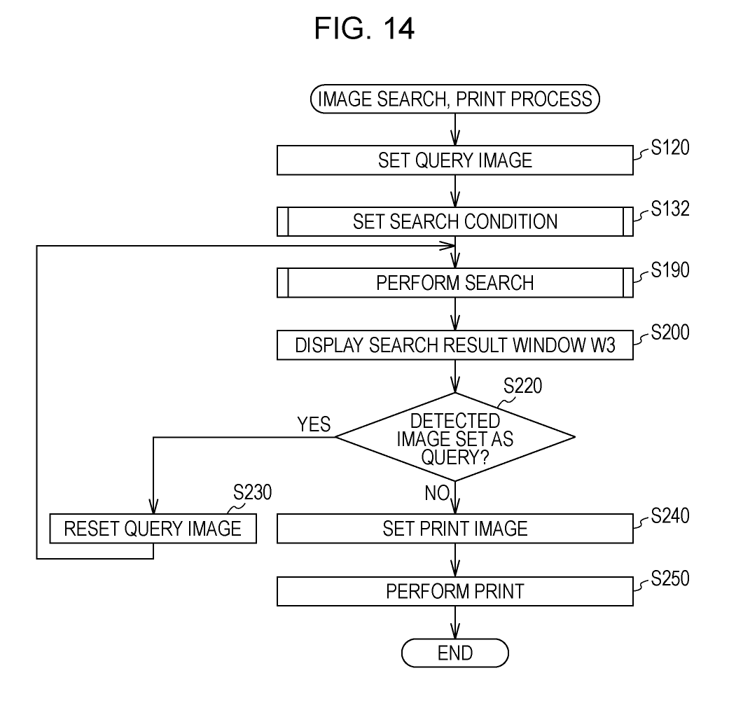

FIG. 14 is a flowchart illustrating a flow of image search and print processing in the second embodiment of the invention. In the image search and print processing (see FIG. 2) according to the first embodiment of the invention, the number of search stages and the search conditions in the respective search stages are set according to the user's designation, while in the image search and print processing according to the second embodiment of the invention, the number of search stages and the search conditions in the respective search stages are automatically set.

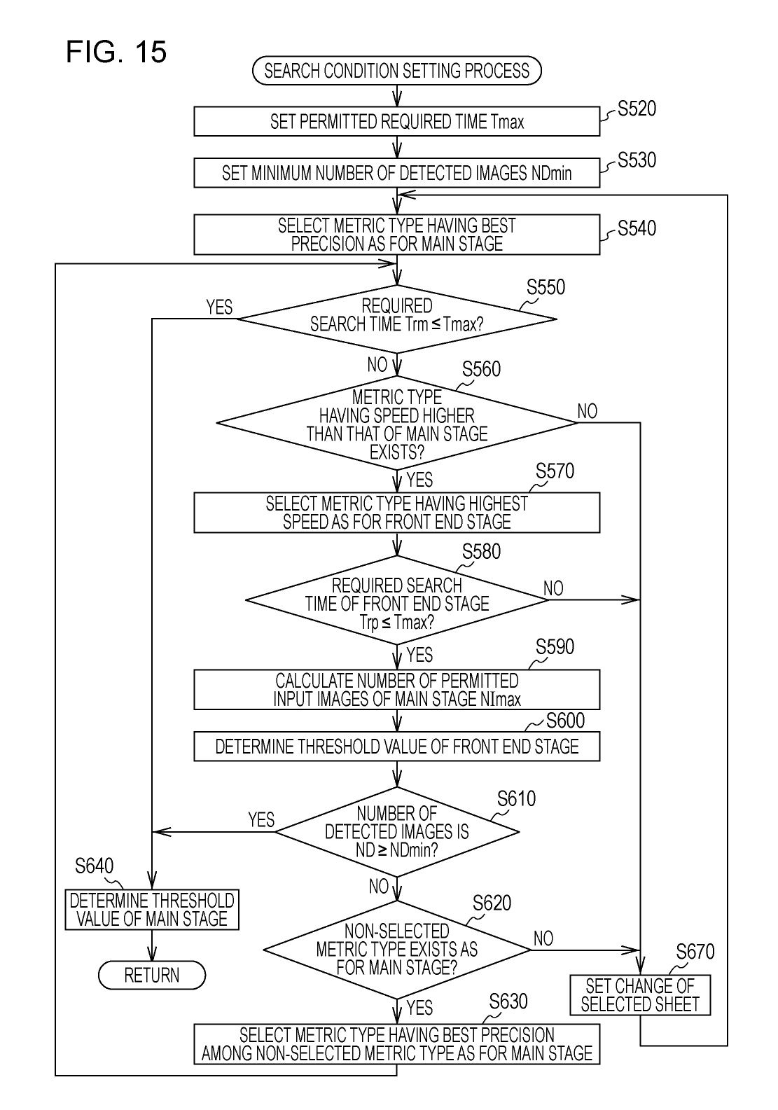

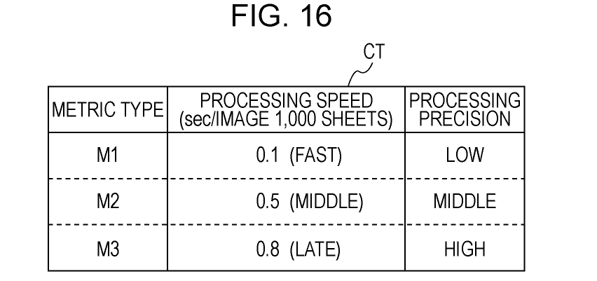

If the image search and print processing (see FIG. 14) starts, a query image is first set (step S120). The query image setting process is performed in the same manner as the first embodiment. Next, the search condition setting process is performed (step S132). FIG. 15 is a flowchart illustrating a flow of the search condition setting process. The search condition setting process is a process that automatically sets the number of search stages and the search conditions in the respective search stages.

In the search condition setting process according to this embodiment, an automatic setting is performed with respect to the metric type and the maximum feature amount distance among the elements (see FIG. 9) that prescribe the search condition of the search stages. As described above, the metric type prescribes the index value indicating the similarity of the query image for the features of the image contents and a method of calculating the corresponding index value. Also, the maximum feature amount is the threshold value in condition determination based on the feature amount distance. With respect to other elements prescribing the search condition of the search stages, predetermined values are adopted. In the embodiment of the invention, the Haar wavelet is adopted as the signature method, RGB is adopted as the color space, default values are adopted as the number of wavelet coefficients and the maximum number of detections, and default setting (in which all weight values are set to 1.0) is adopted as the color channel weight value and the divided region weight value. Also, in the embodiment of the invention, the search using metadata is not performed.

In the search condition setting process, the selectable metric type multiple-choice is preset and prescribed in a multiple-choice table CT. FIG. 16 is an explanatory view illustrating an example of the multiple-choice table CT. In the multiple-choice table CT according to this embodiment of the invention, a high-speed low-accuracy metric M1, a middle-speed middle-accuracy metric M2, and a low-speed high-accuracy metric M3 are set as the metric type multiple-choice. In the embodiment of the invention, the metric type processing speed is indicated as the processing time (seconds) for 1,000 image sheets. This processing speed is an experimental value or a theoretical value in the case where the processing is performed by the printer 100a.

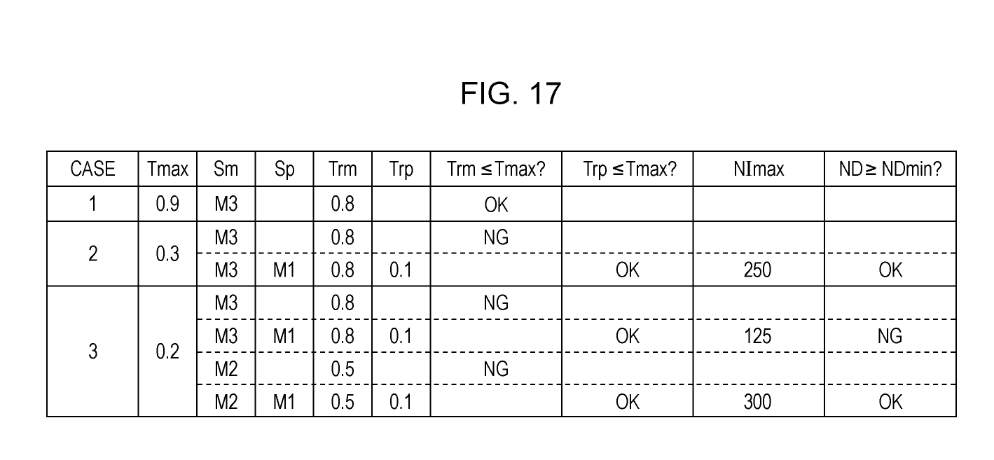

FIG. 17 is an explanatory view concretely illustrating the shape in which search stages and search conditions are set in the search condition setting process. Hereinafter, with reference to the flowchart of FIG. 15 and the explanatory view of FIG. 17, the search condition setting process will be described.

In step S520 of the search condition setting process (see FIG. 15), the permitted time setting unit 218 (see FIG. 13) sets the permitted necessary time Tmax according to a user's designation through a user interface (not illustrated). The permitted necessary time Tmax is the longest time permitted as time necessary for the image search through all search stages. That is, in the search condition setting process, the number of search stages and the search condition in the respective search stages are set in a range that the image search through all the search stage is completed within the permitted necessary time Tmax. Also, a default value may be used as the permitted necessary time Tmax.

In step S530 (see FIG. 15), the minimum image number setting unit 219 (see FIG. 13) sets the minimum number of detected images NDmin according to the user's designation through a user interface. The minimum number of detected image NDmin is the minimum value of the number of detected images Di detected in the image search through all the search stages. That is, in the search condition setting process, the number of search stages and the search condition in the respective search stages are set in a range that the number of detected images Di detected in the image search through all the search stages is equal to or more than the minimum number NDmin of detected images. Also, the minimum number of detected images NDmin is set, for example, on the basis of the number of detected images Di that can be displayed within one page in the search result window W3 (see FIG. 11). A default value may be used as the minimum number of detected images NDmin.

In step S540 (see FIG. 15), the search condition setting unit 213 (see FIG. 13) selects the metric type with the best accuracy as the metric type for the main stage Sm. Here, the main state Sm is a search stage that is finally performed. As shown in FIG. 16, in the embodiment of the invention, since the metric type with the best accuracy is metric M3, the metric M3 is set as the metric type for the main stage Sm. In the case 1 as shown in FIG. 17, the metric M3 has been selected as the metric type for the main stage Sm.

In step S550 (see FIG. 15), the search condition setting unit 213 (see FIG. 13) calculates the necessary search time Trm of the main stage Sm, and determines whether the necessary search time Trm is equal to or less than the permitted necessary time Tmax. If it is determined that the necessary search time Trm is equal to or less than the permitted necessary time Tmax, it is possible to complete the search process in the permitted necessary time Tmax only using the main stage Sm that adopts the metric type having the best accuracy, and thus the search condition configured by the main stage Sm adopting the metric having the best accuracy is set. For example, the necessary search time Trm by the main stage Sm that adopts the metric M3 is 0.8 sec (see FIG. 16). In the description of the invention, the time is expressed as time for 1,000 image sheets. Since in the case 1 as shown in FIG. 17, the permitted necessary time Tmax is set to 0.9 second, it is determined that the necessary search time Trm is equal to or less than the permitted necessary time Tmax. Accordingly, in the case 1, the search condition configured only by the main stage Sm adopting the metric M3 is set. In this case, the search condition setting unit 213 determines the maximum feature amount (i.e. threshold value) of the main stage Sm based on the maximum number of detections (step S640) to complete the search condition setting process.

In step S550 (seep FIG. 15), if it is determined that the necessary search time Trm is equal to or more than the permitted necessary time Tmax, it is difficult to complete the search process within the permitted necessary time Tmax only by the main stage Sm adopting the metric type having the best accuracy. In this case, the search condition setting unit 213 (see FIG. 13) determines whether there is a high-speed metric type multiple-choice that is higher than that of the metric type set as the main stage Sm (step S560). In step S560, if it is determined that the high-speed metric type multiple-choice does not exist, it is difficult to complete the image search within the permitted necessary time Tmax, and thus the change of the metric type multiple-choice is performed (step S670), and the process after step S540 is performed again.

In step S560 (see FIG. 15), if it is determined that the high-speed metric type multiple-choice exists, the search condition setting unit 213 (see FIG. 13) selects the metric type having the highest speed among the multiple-choices as the metric type for the front end stage Sp (step S570). In the case 2 shown in FIG. 17, since the permitted necessary time Tmax is set to 0.3 second, it is determined that the necessary search time Trm (e.g. 0.8 second) in step S550 is more than the permitted necessary time Tmax (see first stage of case 2). In this case, the metric M1 (see FIG. 16) that is the metric type having the highest speed is set as the metric type for the front end stage Sp (see the second stage of case 2).

In step S580 (see FIG. 15), the search condition setting unit 213 (FIG. 13) calculates the necessary search time Trp of the front end stage Sp, and determines whether the necessary search time Trp is equal to or less than the permitted necessary time Tmax. If it is determined that the necessary search time Trp of the front end stage Sp is more than the permitted necessary time Tmax, it is difficult to complete the image search within the permitted necessary time Tmax even if the metric type having the highest speed is adopted, and thus the change of the metric type multiple-choice is performed (step S670), and then the process after the step S540 is performed again.

In step S580 (see FIG. 15), if it is determined that the necessary search time Trp of the front end stage Sp is less than the permitted necessary time Tmax, the search condition setting unit 213 (see FIG. 13) calculates the permitted number of input images NImax of the main stage Sm (step S590). The permitted number of input images NImax is the maximum number that is permitted as the number of target images that are the subject of the main stage Sm. The permitted number of input images NImax is calculated by dividing a difference between the permitted necessary time Tmax and the necessary search time Trp by the speed of the metric type of the main stage Sm. In the case 2 (see the second stage of the case 2) as shown in FIG. 17, since the metric M3 is set as the main stage Sm and the metric M1 is set as the front end stage Sp, the difference (e.g. 0.2 seconds) between the permitted necessary time Tmax (e.g. 0.3 seconds) and the necessary search time Trp (e.g. 0.1 seconds) is divided by the speed of the metric M3 (e.g. 0.8 seconds/1,000 sheets), and thus 250 sheets is calculated as the permitted number of input images NImax.

In step S600 (see FIG. 15), the search condition setting unit 213 (see FIG. 13) determines the maximum feature amount distance (i.e. threshold value) of the front end stage Sp based on the permitted number of input images NImax. The maximum feature amount distance of the front end stage Sp is determined so that the number of detected images Di in the front end stage Sp is less than the permitted number of input images NImax.

In step S610 (see FIG. 15), the search condition setting unit 213 (see FIG. 13) determines whether the number of detected images ND is equal to or more than the minimum number of detected images NDmin. The number of detected images ND is the number of detected images Di that is detected in the image search through all the search stages (i.e. the main stage Sm and the front end stages Sp). In step S610, if it is determined that the number of detected images ND is equal to or more than the minimum number of detected images NDmin, the search condition setting unit 213 determines the maximum feature amount distance (i.e. threshold value) of the main stage Sm based on the maximum number of detected images (step S640), and completes the search condition setting process.

In step S610 (see FIG. 15), if it is determined that the number of detected images ND is less than the minimum number of detected images NDmin, the search condition setting unit 213 (see FIG. 13) determines whether there is any unselected multiple-choice as the metric type of the main stage Sm (step S620). In step S620, if it is determined that the unselected multiple-choice does not exist, the change of the metric type multiple-choice is performed (step S670), and the process after the step S540 is performed again.

On the other hand, in step S620 (see FIG. 15) if it is determined that the unselected multiple-choice exists, the search condition setting unit 213 selects the metric type having the highest accuracy among the unselected multiple-choices as the metric type of the main stage Sm (step S630). At this time, the front end stage Sp is canceled. In the case 3 as shown in FIG. 17, in the case where the metric M3 is set as the main stage Sm and the metric M1 is set as the front end stage Sp, it is determined that the number of detected images ND is less than the minimum number of detected images NDmin (see the second stage of case 3). In this case, the metric M2 (see FIG. 16) that is the metric type having the highest accuracy among the unselected multiple-choices is selected as the metric type of the main stage Sm (see the third stage of the case 3).

In step S630, after the metric type of the main stage Sm is re-selected in step S630 (see FIG. 15), the process after the step S550 is performed again. In the case 3 as shown in FIG. 17 (see third stage of case 3), in the determination in step S550 after the metric M2 is set as the main stage Sm, it is determined that the necessary search time Trm (e.g. 0.5 seconds) of the main state Sm is equal to or more than the permitted necessary time Tmax (e.g. 0.2 seconds). In this case, the metric M1 with the highest speed is selected as the metric type of the front end stage Sp (step S570), the permitted number of input images NImax is calculated (step S590), the maximum feature amount distance (i.e. threshold value) of the front end stage Sp is determined (step S600), and it is determined whether the number of detected images ND is equal to or more than the minimum number of detected images NDmin (step S610). In the determination in step S610, if it is determined that the number of detected images ND is equal to or more than the minimum number of detected images NDmin (see the fourth stage of case 4), the maximum feature amount distance (i.e. threshold value) of the main stage Sm is determined (step S640), and the search condition setting process is completed.

If the search condition setting process (step S132 in FIG. 14) is completed, in the same manner as the first embodiment as indicated in FIG. 2, processes subsequent to the search execution process (step S190 in FIG. 14) using the set search conditions are performed.

As described above, in the image search and print processing according to the second embodiment of the invention, the permitted necessary time Tmax for the image search is set, the number of search stages for the image search and the search condition in the respective search stages are set based on the permitted necessary time Tmax, and the image search of the search stages using the set search conditions are sequentially performed. Accordingly, in the image search and the print processing according to the second embodiment of the invention, it is possible to automatically set the number of search stages in the image search and the search conditions, and thus the user convenience can be improved.

That is, in the image search and print processing according to the second embodiment of the invention, the query image is set as the basis of the image search, search conditions that specify the index values (i.e. feature amount distance) that indicates the similarity of the query images for the features of the image contents with respect to the respective search stages, the method of calculating the corresponding index values (e.g. metrics M1, M2, and M3), and the threshold values (i.e. maximum feature amount distances) for the corresponding index values are set, the index values are calculated by the set calculation method in the respective search stages, and the image is detected by the determination using the threshold values. Accordingly, in the image search and print processing according to the second embodiment of the invention, it is possible to automatically set the search conditions that specify the number of search stages, the index values indicating the similarity, the index value calculation method, and the threshold value for the index values, and thus the user convenience can be improved.

Also, in the image search and print processing according to the second embodiment of the invention, since the search conditions are set by selecting one of a plurality of calculation methods (e.g. metrics M1, M2, and M3) of which at least one of the processing speed and the processing accuracy is different, the optimum number of search stages and search conditions in consideration of the balance between the processing speed and the processing accuracy are automatically set, and the user convenience can be further improved. That is, in the image search and print processing according to the second embodiment of the invention, the search conditions are set so that the calculation method having a much better processing accuracy is selected in a range where the image search through all the search stages is completed within the permitted necessary time Tmax, and thus the optimum number of search stages and the search conditions in consideration of the processing speed and the processing accuracy can be automatically set.

Also, in the image search and print processing according to the second embodiment of the invention, since the minimum number of detected images NDmin is set and the number of search stages and the search conditions for the respective search stages are set in a range where the number of detected images Di in the image search through all the search stages is equal to or more than the minimum number of detected images NDmin so that the search conditions for realizing the image search with a good processing accuracy can be more adopted, the optimum number of search stages and search conditions are automatically set in a range where the number of detected images Di does not become too small.

Also, in the image search and print processing according to the second embodiment of the invention, the detected images Di detected in the image search using the automatically set search conditions can be printed.

### C. Modified Embodiments

The invention is not limited to the above described embodiments or examples, and may be embodied in diverse aspects without departing from the scope of the invention. For example, the following modifications are possible.

### C1. Modified Example 1

In the respective embodiments of the invention as described above, it is exemplified that the image search and print processing is performed with respect to the image (i.e. image data (or image files)) stored in the memory card MC as the target image. However, the target image can be optionally set in the image search and print processing. For example, the image stored in a predetermined region of the internal memory 120 (see FIG. 1) may be set as the target image, or the image stored in a storage region provided in another device that is connected to the printer 100 through a cable or a network may be set as the target image.

### C2. Modified Example 2

In the respective embodiments of the invention, the contents or layout of the initial window W1, the search option window W2, and the search result window W3 are merely exemplary, and diverse modifications can be made. These windows may be properly modified according to an executable process of the printer 100. For example, although in the respective embodiments of the invention, it is exemplified that the printer 100 designates the query image in three kinds of methods (i.e. image file designation, portrayal, and color selection), it may be designated that one of the above-mentioned methods may not designate the query image, or another method except for the above three methods (e.g. a method of selecting a preset template image) may designate the query image. The initial window W1 (see FIG. 3) may be properly modified according to the query image designation method that is possible in the printer 100.

Also, the multiple-choices (e.g. a camera maker, a camera model, a file size, or the like: see FIG. 7) in the respective elements that prescribe the search conditions for the search using metadata are merely exemplary, and may be modified in diverse manner. According to the modifications of such elements or multiple-choices, the search option window W2 (see FIG. 5) is properly modified. Also, it is not necessary for the printer 100 to be able to execute the search using metadata, and also it is not necessary for the search option window W2 to include metadata condition designation area Ar43 for designating the search condition for the search using metadata.

Also, the elements (e.g. the signature method, the metric type, the color space, and the like: see FIGS. 5 and 9) for prescribing the search conditions for the search using image contents and the multiple-choices in the respective elements (e.g. the color histogram, the Haar wavelet, and the like: see FIG. 8) as described above in the respective embodiments are just exemplary, and diverse modifications may be made. According to the modifications of such elements or multiple-choices, the search option window W2 (see FIG. 5) is properly modified. For example, it may not be necessary to include the color channel weight values or divided region weight values as the element prescribing the search conditions. Also, as the multiple-choice of the signature method that is one of elements that prescribing the search conditions, another multiple-choice such as a color space or SHA hash sum, wavelet coefficients using a wavelet base except for the Haar wavelet, or the like, may be set. Also, as the multiple-choice of the metric type in the case where the signature method is set as the Haar wavelet, a multiple-choice of different feature amount distance calculation methods of the wavelet series coefficients (see box Bo49 in FIG. 9) may be set.

### C3. Modified Example 3

The method of calculating the feature amount distance as the index value indicating the similarity between the query image and the target image in the respective embodiments of the invention is merely exemplary, and diverse modifications may be made. For example, although it is exemplified that in the embodiment of the invention, in the calculation equation (i.e. Equation (11)) of the feature amount distance D(Q, T) in the case where the signature method is set as the Haar wavelet and the metric type is set as the metric M1, the coordinates, at which the wavelet coefficients Q(i, j) of the query image is zero, is excluded from the subject of total summing for the high-speed processing, the coordinates at which the wavelet coefficients Q(i, j) is zero may be set to be the subject of total summing. Although in Equation (11), the wavelet coefficients Q(i, j) of the target image and the query image and T(i, j) have been quantized, the coefficients before being quantized may be used. Even in the case where the metric type is set as the real metric M4, the modifications may be made in the same manner.

### C4. Modified Example 4

In the second embodiment of the invention, it is exemplified that in the search condition setting process (see FIG. 15), the number of search stages and the metric types in the respective search stages are automatically set. However, in the search condition setting process, the combination of the signature method and the metric type in the search stage may be automatically set. That is, the signature method and the metric type may be automatically set by pre-setting the multiple-choice of the combination of the signature method and the metric type of which at least one of the processing speed and the processing accuracy is different and selecting a specified combination among the plurality of multiple-choices based on the determination using the permitted necessary time Tmax. Also, in the search condition setting process, whether the execution of the search using metadata is necessary or the search condition for the search using metadata may be automatically set. For example, in the search using metadata, the item concurrence rate (i.e. a rate of the number of item concurrence condition to the number of condition-set items (e.g. a camera maker or a file size)) as the threshold value of condition determination or the keyword concurrence rate (the rate of the number of concurrence keywords to the number of set keywords) as the threshold value of condition determination may be automatically set. For example, in the case where the permitted number of input images NImax of the main stage Sm is calculated (step S590 in FIG. 15), the concurrent item rate may be automatically set based on the permitted number of input images NImax. In this case, the concurrent item rate or the concurrent keyword rate is used as the index value indicating the similarity between the query image and the target image.

Although it is exemplified that in the search condition setting process (see FIG. 15) according to the second embodiment of the invention, the search condition is composed of one (i.e. a main stage Sm) or two (i.e. a main stage Sm and a front end stage Sp) search stages, the search condition may be automatically set so that the search stage includes three or more search conditions. Also, in the search condition setting process according to the second embodiment of the invention, the setting of the minimum number of detected images NDmin (step S530) and the determination (step S610) using the minimum number of detected images NDmin may be omitted.

### C5. Modified Example 5

In the respective embodiments of the invention, the configuration of the printer 100 as the image processing apparatus is merely exemplary, and may be diversely modified. Also, in the respective embodiments, the image search and print processing by the printer 100 as the image processing apparatus has been described. However, a part or the whole process may be performed by other kinds of image processing apparatus, such as a server, a personal computer, a digital still camera, a digital video camera, or the like. Also, the printer 100 is not limited to the ink jet printer, but may be other types of printer, for example, a laser printer, a dye sublimation printer, or the like.

In the above-described embodiments, a part of the configuration implemented by hardware may be replaced by software, or a part of the configuration implemented by software may be replaced by hardware.

In the case where a part or the whole part of functions is implemented by software, the software (or a computer program) may be provided in the form stored in a computer readable recording medium. In the invention, the computer readable recording medium is not limited to portable recording medium such as a flexible disk or CD-ROM, and may include an internal storage device in a computer such as various kinds of RAM or ROM, and an external storage device fixed to a computer such as hard disk or the like.

What is claimed is:

1. An image processing apparatus that performs image search comprising:
a condition designation window display unit that displays a condition designation window which includes condition designation regions by stages for designating search conditions for features of image contents in a plurality of search stages in series relations with one another, and a plurality of tags that designate display states of the condition designation regions by stages as tags corresponding to the plurality of search stages;
a search condition setting unit that sets the search conditions in the plurality of search stages in accordance with the designations through the condition designation window; and
an image search unit that sequentially performs the image search for the plurality of search stages by using the set search conditions.

2. The image processing apparatus according to claim 1, wherein the condition designation regions by stages are regions where one of the plurality of search conditions for realizing the image search, in which at least either of the processing speeds and processing accuracies are different from one another, is designated as the search condition to be adopted.

3. The image processing apparatus according to claim 1, wherein the condition designation window display unit displays the condition designation window which includes a stage number designation region for designating the number of the search stages; and the search condition setting unit sets the search conditions in the search stages the number of which is designated through the condition designation window.

4. The image processing apparatus according to claim 1, further comprising a query image setting unit that sets a query image as the basis of the image search;
wherein the search condition setting unit sets the search condition on the similarity of the query image with the feature.

5. The image processing apparatus according to claim 4, wherein the query image setting unit sets an image that is specified by any one of methods for image file designation, portrayal, and color designation as the query image.

6. The image processing apparatus according to claim 4, wherein the query image setting unit sets one image detected by the image search as a new query image.

7. The image processing apparatus according to claim 4, wherein the search condition setting unit sets the search condition on the similarity weighted for each image region.

8. The image processing apparatus according to claim 4, wherein the search condition setting unit sets the search condition on the similarity weighted for each channel of a color space of the image.

9. The image processing apparatus according to claim 1, wherein the image search unit performs the image search of the rear-end search stage with respect to the image detected by the image search of the front-end search stage in the series relations.

10. The image processing apparatus according to claim 1, wherein the search condition setting unit sets the search condition on attributes of the image in addition to the search condition on the features of the image contents; and
the image search unit performs the image search using the search condition on the attributes of the image and the search condition on the features of the image contents.

11. The image processing apparatus according to claim 1, wherein the condition designation window display unit displays the condition designation window in which the condition designation regions by stages that correspond to only one search stage are simultaneously displayed in accordance with the designation through the tags.

12. The image processing apparatus according to claim 1, wherein the feature is at least either of the feature indicating color distribution in the image and the feature calculated by wavelet decomposition of the image.

13. The image processing apparatus according to claim 1, further comprising:
a print image setting unit that sets the detected image to be printed among the images detected by the image search; and
a printing unit that performs printing of the detected image to be printed.

14. The image processing apparatus according to claim 13, further comprising a search result window display unit that displays a search result window including a detected image display area for displaying the detected images in line and a print designation area for designating the detected image to be printed;
wherein the print image setting unit sets the detected image that corresponds to the image displayed in the print designation area according to a predetermined manipulation of a user in the search result window as the detected image to be printed.

15. An image processing method that performs image search using a computer, comprising:
(a) displaying a condition designation window which includes condition designation regions by stages for designating search conditions for features of image contents in a plurality of search stages in series relations with one another, and a plurality of tags that designate display states of the condition designation regions by stages as tags corresponding to the plurality of search stages;
(b) setting the search conditions in the plurality of search stages in accordance with the designations through the condition designation window; and
(c) sequentially performing the image search for the plurality of search stages by using the set search conditions.

16. A product recorded with a computer program for image processing that performs image search, causing a computer to execute the functions of:
a condition designation window display function that displays a condition designation window which includes condition designation regions by stages for designating search conditions for features of image contents in a plurality of search stages in series relations with one another, and a plurality of tags that designate display states of the condition designation regions by stages as tags corresponding to the plurality of search stages;
a search condition setting function that sets the search conditions in the plurality of search stages in accordance with the designations through the condition designation window; and
an image search function that sequentially performs the image search for the plurality of search stages by using the set search conditions.
